(19) United States
(12) Patent Application Publication
(10) Pub. No.: US 2017/0224140 A1
(43) Pub. Date: Aug. 10, 2017

(54) INTERACTION TECHNIQUES FOR FLEXIBLE DISPLAYS

(71) Applicants: ROEL VERTEGAAL, PERTH ROAD (CA); JUSTIN LEE, SAN FRANCISCO, CA (US); YVES BEHAR, SAN FRANCISCO, CA (US); PICHAYA PUTTORNGUL, NEW YORK, NY (US)

(72) Inventors: ROEL VERTEGAAL, PERTH ROAD (CA); JUSTIN LEE, SAN FRANCISCO, CA (US); YVES BEHAR, SAN FRANCISCO, CA (US); PICHAYA PUTTORNGUL, NEW YORK, NY (US)

(21) Appl. No.: 15/293,419

(22) Filed: Oct. 14, 2016

Related U.S. Application Data
(63) Continuation of application No. 14/314,589, filed on Jun. 25, 2014, now abandoned.
Application No. 14/314,589 is a continuation of application No. 13/589,732, filed on Aug. 20, 2012, now abandoned.
Application No. 13/589,732 is a continuation of application No. 12/459,973, filed on Jul. 10, 2009, now abandoned.
Application No. 12/459,973 is a continuation of application No. 11/731,447, filed on Mar. 30, 2007, now abandoned.
(60) Provisional application No. 60/788,405, filed on Mar. 30, 2006.

(51) Int. Cl. A47G 19/22; G06F 1/16; G06F 3/01; G06F 3/0346

(52) U.S. Cl. CPC A47G 19/2227; G06F 3/0346; G06F 1/1652; G06F 3/017; A47G 19/2272; A47G 2019/2238; A47G 2019/2244; A47G 2019/225

(57) ABSTRACT

The invention relates to a set of interaction techniques for obtaining input to a computer system based on methods and apparatus for detecting properties of the shape, location and orientation of flexible display surfaces, as determined through manual or gestural interactions of a user with said display surfaces. Such input may be used to alter graphical content and functionality displayed on said surfaces or some other display or computing system. The invention also relates to interactive food or beverage container with associated computing apparatus inside its body, and a curved multitouch display on its surface, associated interaction techniques for curved multitouch displays, methods of use, and apparatus for refilling said electronic food or beverage container.

### CROSS-REFERENCE TO RELATED APPLICATIONS

This application is a continuation-in-part of U.S. patent application Ser. No. 11/731,447, filed Mar. 30, 2007, which claims the benefit of priority to U.S. Provisional Application Ser. No. 60/788,405, filed Mar. 30, 2006.

Each of the applications and patents cited in this text, as well as each document or reference cited in each of the applications and patents (including during the prosecution of each issued patent; “application cited documents”), and each of the U.S. and foreign applications or patents corresponding to aid/or claiming priority from any of these applications and patents, and each of the documents cited or referenced in each of the application cited documents, are hereby expressly incorporated herein by reference. More generally, documents or references are cited in this text, either in a Reference List before the claims, or in the text itself; and, each of these documents or references (“herein-cited references”), as well as each document or reference cited in each of the herein-cited references (including any manufacturer's specifications, instructions, etc.), is hereby expressly incorporated herein by reference. Documents incorporated by reference into this text may be employed in the practice of the invention.

### FIELD OF THE INVENTION

The present invention relates generally to input and interaction techniques associated with flexible display devices.

### BACKGROUND OF THE INVENTION

In recent years, considerable progress has been made towards the development of thin and flexible displays. U.S. Pat. No. 6,639,578 cites a process for creating an electronically addressable display that includes multiple printing operations, similar to a multi-color process in conventional screen printing. Likewise, U.S. Pat. Application No. 2006/0007368 cite a display device assembly comprising a flexible display device being rollable around an axis. A range of flexible electronic devices based on these technologies, including full color, high-resolution flexible OLED displays with a thickness of 0.2 mm are being introduced to the market (14). The goal of such efforts is to develop displays that resemble the superior handling, contrast and flexibility of real paper.

As part of this invention we devised an apparatus for tracking interaction techniques for flexible displays that uses a projection apparatus that projects images generated by a computer onto real paper, of which the shape is subsequently measured using a computer vision device. Deformation of the shape of the paper display is then used to manipulate in real time said images and/or associated computer functions displayed on said display. It should be noted that the category of displays to which this invention pertains is very different from the type of rigid-surface LCD displays cited in, for example, U.S. Pat. No. 6,567,068 or 6,573,883 which can be rotated around their respective axes but not deformed.

Further, as a part of this invention, we devised an apparatus for an interactive food or beverage container with an associated flexible display curved around its surface. The display can sense multitouch input, which is processed by an onboard computer that drives the display unit and associated software programs. The interactions on this unit are different from other multitouch rigid display surface computing devices, such as the Apple iPhone, U.S. Pat. No. 7,479,949, in that they operate on a cylindrical surface, and thus operate in a three-dimensional rather than a two-dimensional coordinate system, see also U.S. Pat. Nos. 2006/0010400 and 2006/0036944.

U.S. Pat. No. 6,859,745, which teaches the use of a radio circuit to identify the package is different from the instant apparatus as it does not have an associated display unit, limiting its interactivity.

WO 00/55743 teaches of an interactive electroluminescent display disposed on packaging. While this invention features a touch switch, it does not describe a touch-sensitive display surface. The display is limited to providing illumination of the contents or graphics on the package, and does not serve as a computer display.

U.S. Pat. No. 7,098,887 teaches of a thermoelectric unit with flexible display mounted on a commercial hot beverage holder. The invention is limited to displaying visual effects on the display unit based on the heat of the beverage inside the container.

U.S. Patent Application No. 2004/0008191 teaches of a flexible display mounted on a plastic substrate, and the use of bending as a means to provide input to computing apparatus on said substrate. This invention discusses the use of flexible properties of said display for the purposes of input, not rigid applications of the display. Prior art, which include bendable interfaces such as ShapeTape (1) and Gummi (20) demonstrates the value of incorporating the deformation of computing objects for use as input for computer processes. However, in this patent, we propose methods for interacting with flexible displays that rely on deformations of the surface structure of the display itself. While this extends work performed by Schwesig et al (17), which proposed a credit card sized computer that uses physical deformation of the device for browsing of visual information, it should be noted that said device did not incorporate a flexible material, and did not use deformation of the display. Instead, it relied on the use of touch sensors mounted on a rigid LCD-style display body.

The use of projection to simulate computer devices on three dimensional objects is also cited in prior art. SmartSkin (18) is an interactive surface that is sensitive to human finger gestures. With SmartSkin, the user can manipulate the contents of a digital back-projection desk using manual interaction. Similarly, Rekimoto's Pick and Drop (16) is a system that lets users drag and drop digital data among different computers by projection onto a physical object. In Ishii's Tangible User Interface (TUI) paradigm (5), interaction with projected digital information is provided through physical manipulation of real-world objects. In all of such systems, the input device is not the actual display itself, or the display is not on the actual input device. With DataTiles (17). Rekimoto et al proposed the use of plastic surfaces as widgets that with touch-sensitive control properties for manipulating data projected onto other plastic surfaces. Here, the display surfaces are again two-dimensional and rigid body.

In DigitalDesk (24), a physical desk is augmented with electronic input and display. A computer controlled camera and projector are positioned above the desk image processing is used to determine which page a user is pointing at. Object character recognition transfers content between real paper and electronic documents projected on the desk. Weliner demonstrates the use of his system with a calculator that blurs the boundaries between the digital and physical world by taking a printed number and transferring it into an electronic calculator. Interactive Paper (11) provides a framework for three prototypes. Ariel (11) merges the use of engineering drawings with electronic information by projecting digital drawings on real paper laid out on a planar surface. In Video Mosaic (11), a paper storyboard is used to edit video segments. Users annotate and organize video clips by spreading augmented paper over a large tabletop. Cameleon (11) simulates the use of paper flight strips by air traffic controllers, merging them with the digital world. Users interact with a tablet and touch sensitive screen to annotate and obtain data from the flight strips. Paper Augmented Digital Documents (3) are digital documents that are modified on a computer screen or on paper. Digital copies of a document are maintained in a central database and if needed, printed to paper using IR transparent ink. This is used to track annotations to documents using a special pen. Insight Lab (9) is an immersive environment that seamlessly supports collaboration and creation of design requirement documents. Paper documents and whiteboards allow group members to sketch, annotate, and share work. The system uses bar code scanners to maintain the link between paper, whiteboard printouts, and digital information.

Xlibris (19) uses a tablet display and paper-like interface to include the affordances of paper while reading. Users can read a scanned image of a page and annotate it with digital ink. Annotations are captured and used to organize information. Scrolling has been removed from the system: pages are turned using a pressure sensor on the tablet. Users can also examine a thumbnail overview to select pages. Pages can be navigated by locating similar annotations across multiple documents. Fishkin et al. (2) describe embodied user interfaces that allow users to use physical gestures like page turning, card flipping, and pen annotation for interacting with documents. The system uses physical sensors to recognize these gestures. Due to space limitations we limit our review: other systems exist that link the digital and physical world through paper. Examples include Freestyle (10), Designers' Outpost (8), Collaborage (12), and Xax (6). One feature common to prior work in this area is the restriction of the use of physical paper to a flat surface. Many project onto or sense interaction in a coordinate system based on a rigid 2D surface only. In our system, by contrast, we use as many of the three dimensional affordances of flexible displays as possible.

In Illuminating Digital Clay (15), Piper et al. proposed the use of a laser scanner to determine the deformation of a clay mass. This deformation was in turn used to alter images projected upon the clay mass through a projection apparatus. The techniques presented in this patent are different in a number of ways. Firstly, our display unit is completely flexible, can be duplicated to work in unison with other displays of the same type and move freely in three-dimensional space. They can be folded 180 degrees around any axis or sub-axes, and as such completely implement the functionality of two-sided flexible displays. Secondly, rather than determining the overall shape of the object as a point cloud, our input techniques rely on determining the 3D location of specific marker points on the display. We subsequently determine the shape of the display by approximating a Bezier curve with control points that coincide with these marker locations, providing superior resolution. Thirdly, unlike Piper (15), we propose specific interaction techniques based on the 3D manipulation and folding of the display unit.

The advantages of regular paper over the windowed display units used in standard desktop computing are manifold (21). In the Myth of the Paperless Office (21) Sellen analyzes the use of physical paper. She proposed a set of design principles for incorporating affordances of paper documents in the design of digital devices, such as 1) Support for Flexible Navigation, 2) Cross Document Use, 3) Annotation While Reading and 4) Interweaving of Reading and Writing.

Documents presented on paper can be moved in and out of work contexts with much greater ease than with current displays. Unlike GUI windows or rigid LCD displays, paper can be folded, rotated and stacked along many degrees of freedom (7). It can be annotated, navigated and shared using extremely simple gestural interaction techniques. Paper allows for greater flexibility in the way information is represented and stored, with a richer set of input techniques than currently possible with desktop displays. Conversely, display systems currently support properties unavailable in physical paper, such as easy distribution, archiving, querying and updating of documents. By merging the digital world of computing with the physical world of flexible displays we increase value of both technologies.

### SUMMARY OF THE INVENTION

The present invention relates to a set of interaction techniques for obtaining input to a computer system based on methods and apparatus for detecting properties of the shape, location and orientation of flexible display surfaces, as determined through manual or gestural interactions of a user with said display surfaces. Such input may be used to alter graphical content and functionality displayed on said surfaces or some other display or computing system.

The present invention also relates to a food or beverage container with a curved interactive electronic display surface, and methods for obtaining input to a computer system associated with said container or some curved display, through multi-finger and gestural interactions of a user with a curved touch screen disposed on said display. Such input may be used to alter graphical content and functionality rendered on said display. The invention also pertains to a number of context-aware applications associated with the use of an electronic food or beverage container, and a refilling station.

One aspect of the invention is a set of interaction techniques for manipulating graphical content and functionality displayed on flexible displays based on methods for detecting the shape, location and orientation of said displays in 3 dimensions and along 6 degrees of freedom, as determined through manual or gestural interaction by a user with said display.

Another aspect of the invention is a capture and projection system, used to simulate or otherwise implement a flexible display. Projecting computer graphics onto physical flexible materials allows for a seamless integration between images and multiple 3D surfaces of any shape or form, one that measures and corrects for 3D skew in real time.

Another aspect of the invention is the measurement of the deformation, orientation and/or location of flexible display surfaces, for the purpose of using said shape as input to the computer system associated with said display. In one embodiment of the invention, a Vicon Motion. Capturing System (23) or equivalent computer vision system is used to measure the location in three dimensional space of retro-reflective markers affixed to or embedded within the surface of the flexible display unit. In another embodiment, movement is tracked through wireless accelerometers embedded into the flexible display surface in lieu of said retro-reflective markers, or deformations are tracked through some fiber optics embedded in the display surface.

One embodiment of the invention is the application of said interaction techniques to flexible displays that resemble paper. In another embodiment, the interaction techniques are applied to any form of polymer or organic light emitting diode-based electronic flexible display technology.

Another embodiment of the invention is the application of said interaction techniques to flexible displays that mimic or otherwise behave as materials other than paper, including but not limited to textiles whether or not worn on the human body, three-dimensional objects, liquids and the likes.

In another embodiment, interaction techniques apply to projection on the skin of live or dead human bodies, the shape of which is sensed via computer vision or embedded accelerometer devices.

Another aspect of the invention is the apparatus for an interactive food or beverage container with a curved display and curved multitouch input device on its surface, and with sensors and computing apparatus inside that drives software functionality rendered on said display.

One aspect of the invention is a set of interaction techniques for manipulating graphical content and functionality displayed on curved displays based on methods for detecting manual or gestural interaction by a user with said display.

Another aspect of the invention is methods of using an interactive food or beverage container, including but not limited to ordering methods, promotions and advertising methods, children's game methods and others.

In one embodiment, the invention relates to electronic beverage container, a modular system of components consisting of, but not limited to, a customizable lid or top, a container/display component, a hardware computer component, and an optional base component that provides power and connectivity. In another embodiment, the invention relates to an apparatus and process for refilling said interactive food or beverage container.

Unless otherwise defined, all technical and scientific terms used herein have the same meaning as commonly understood by one of ordinary skill in the art to which this invention pertains. Although methods and materials similar or equivalent to those described herein can be used in the practice of the present invention, suitable methods and materials are described below. All publications, patent applications, patents, and other references mentioned herein are expressly incorporated by reference in their entirety. In cases of conflict, the present specification, including definitions, will control. In addition, materials, methods, and examples described herein are illustrative only and are not intended to be limiting.

Other features and advantages of the invention will be apparent from and are encompassed by the following detailed description and claims.

### BRIEF DESCRIPTION OF THE DRAWINGS

The following Detailed Description, given by way of example, but not intended to limit the invention to specific embodiments described, may be understood in conjunction with the accompanying figures, incorporated herein by reference, in which:

FIG. 1 shows a Hold Gesture with flexible display surface (1). Note that flexible display surfaces and fingers in FIG. 1 through 10 may include some (hidden) marker(s) (3) according to FIG. 11 or FIG. 12 that have not been included in the drawings for reasons of clarity.

FIG. 2 shows a Collocate Gesture with flexible display surfaces (1).

FIG. 3 shows a Collate Gesture with flexible display surfaces (1).

FIG. 4 shows a Flip Gesture, Fold and Half-fold Gestures with flexible display surface (1).

FIG. 5 shows a Roll Gesture with flexible display surface (1) with markers (3).

FIG. 6 shows a Bend Gesture with flexible display surface (1) and foldline (2).

FIG. 7 shows a Rub Gesture with flexible display surface (1).

FIG. 8 shows a Staple Gesture with flexible display surface (1).

FIG. 9 shows a Pointing Gesture with flexible display surface (1).

FIG. 10 shows a Multi-handed Pointing Gesture with flexible display surface (1).

FIG. 11 shows a Flexible display surface (1) with markers (3).

FIG. 12 shows another embodiment of flexible display surface (1) made of fabric or similar materials with markers (3).

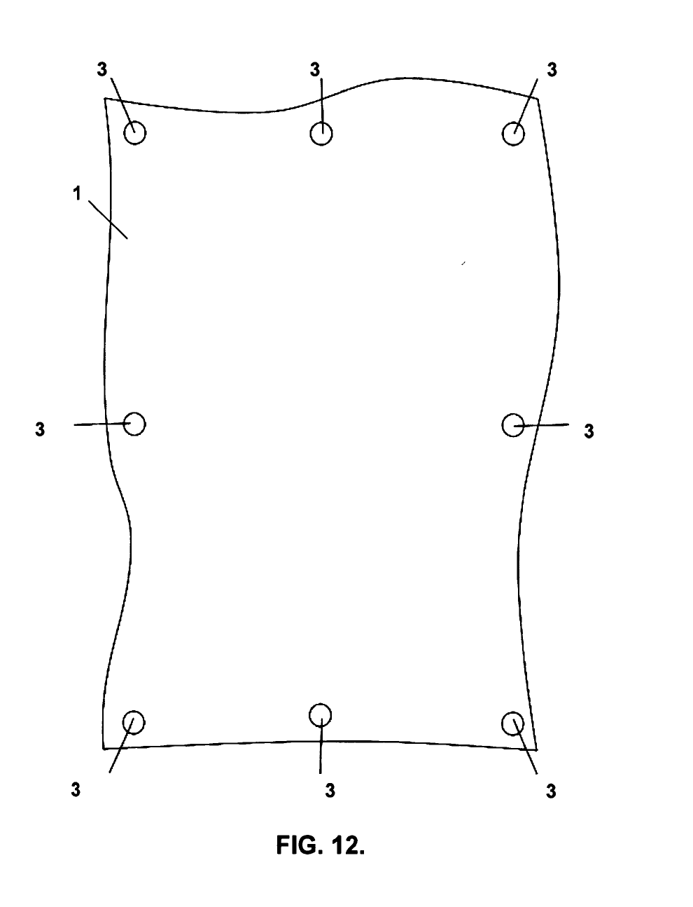

FIG. 13 shows a System apparatus for tracking flexible display surface (1) through computer vision cameras emitting infrared light (4) mounted above a workspace with user (7), where markers (3) affixed to flexible display surface (1) reflect infrared light emitted by computer vision cameras (4). Optionally, digital projection system (5) projects images of the modeled flexible display surfaces rendered with textures back onto said flexible display surfaces.

FIG. 14 shows interactive food or beverage container with multi-touch user interface on a curved display 103, with customizable lid 101. Also shown are the non-dominant hand 100 holding the container and the dominant hand 102 interacting with its touch screen.

FIG. 15 shows components of the interactive food or beverage container with customizable lid 201, interactive display/container component 202, computer, network and power component 203 and accessory base 204. Also shown an optional flattened area of the display surface 202 that provides the user with the orientation of said container.

FIG. 16 shows customizable lid design embodiments. The computer, network and power component recognizes the customizable lid placed on the interactive display/container component, and signals the user interface to alter its appearance accordingly. This allows a single interactive display/container component to serve multiple uses and re-uses, such as but not limited to: children's drink bottle 301; hiker's filtration bottle 302; exercise drink bottle 303; theme park bottle 304; or coffee mug 305.

FIG. 17 shows interactive customized form factor embodiments with associated software functionality and/or promotional displays: hiker's filtration bottle 401; exercise drink bottle 402; theme park bottle 403; coffee mug 404; sport info food/beverage container 405; fast food drink bottle 406; morning commute mug 407; refillable pop bottle 408 and children's drink bottle 409. Each contextual lid may activate an associated software functionality, for example, but not limited to: water purification indicator 410; exercise or nutritional information indicator 411; theme park ride interface 412; rewards points or carbon credit tracking interface 413; current sports player information interface 414; remote ordering menu 415; rss reader 416; promotional content 417; fingerprint identification system 418 and game 419.

FIG. 18 shows an example of containers which are placed next to or on top of each other their display surface and thus may be combined to form a larger display. Also shown an example of six containers forming one, larger, segmented display. This non-limiting example shows a promotional ad campaign running across the segmented display when containers are stacked on a coffee counter in a coffee store.

FIG. 19 shows a user holding a cylindrical display embodiment 601 with two hands, and rotating said cylindrical display so as to scroll through a document, web page or image that is larger than what can be rendered on that display. A scroll may be performed in either direction, with the display rotated around its longitudinal axis 602.

FIG. 20 shows a user performing a circular movement around an axis 702 that is non-concentrical but parallel to the longitudinal axis 703 of a cylindrical display embodiment 701. In the embodiment of a container, this action causes the fluids inside the container to swirl. This action can be sensed and used, in one embodiment, to scroll graphics on the display with physics action, or as input to a game.

FIG. 21 shows a user holding a curved display embodiment with the non-dominant hand, placing the finger of the dominant hand on the display, and moving the finger laterally. In this non-limiting example, this action is used to move graphic objects rendered on the display.

FIGS. 22A and 22B show a user holding a curved display embodiment with the non-dominant hand, placing two fingers of the dominant hand on the display (FIG. 22A), and moving both fingers away from ac other (FIG. 22B). This may be used to zoom graphics on the display.

FIGS. 23A and 23B show a user holding a curved display embodiment with the non-dominant hand, placing two fingers of the dominant hand on the display (FIG. 23A), and moving one finger away from the other while maintaining the location of the first finger (FIG. 23B). This may be used to zoom graphics on the display in a way that allows the graphics underneath the first finger to stay stationary.

FIG. 24 shows the user rubbing a curved display embodiment with one hand, while holding it with the other. The rub gesture moves left and right and from up to down, and can be performed with the display upright or sideways. One non-limiting example use for this action is in deleting or erasing information rendered on the display.

FIG. 25 shows the user holding a cylindrical display embodiment with one hand then tilting it from upright to a certain angle. This can be used for example, to move graphics on the display or control playback speed of a movie rendered on the display.

### DETAILED DESCRIPTION OF THE INVENTION

### Definitions

“Flexible Display” or “Flexible Display Surface” means any display surface made of any material, including, but not limited to displays constituted by projection and including, but not limited to real and electronic paper known in the art, based on Organic

Light Emitting Devices or other forms of thin, thin-film or e-ink based technologies such as, e.g., described in U.S. Pat. No. 6,639,578, cardboard, Liquid Crystal Diode(s), Light Emitting Diode(s), Stacked Organic, Transparent Organic or Polymer Light Emitting Device(s) or Diode(s), Optical Fibre(s), Styrofoam, Plastic(s), Epoxy Resin, Textiles, E-textiles, or clothing, skin or body elements of a human or other organism, living or dead, Carbon-based materials, or any other three-dimensional object or model, including but not limited to architectural models, and product packaging. Within the scope of this application, the term is can be interpreted interchangeably as paper, document or paper window, but will not be limited to such interpretation.

The term “Paper Window” refers to one embodiment of a flexible display surface implemented by tracking the shape, orientation and location of a sheet of paper, projecting back and image onto said sheet of paper using a projection system, such that it constitutes a flexible electronic display. Within the scope of this application, the term is may be interpreted as interchangeable with flexible display, flexible display surface or document, but the terms flexible display, document and flexible display surface shall not be limited to such interpretation.

The term “document” is synonymous for Flexible Display or FlexibleDisplay Surface.

“Marker” refers to a device that is affixed to a specific location on a flexible display surface for the purpose of tracking the position or orientation of said location on said surface. Said marker may consist of a small half-sphere made of material that reflects light in the infrared spectrum for the purpose of tracking location with an infrared computer vision camera. Said marker may also consist of an accelerometer that reports to a computer system for the purpose of computing the location of said marker, or any other type of location tracking system known in the art. A similar term used in this context is “point.”

“Fold” is synonymous with “Bend,” wherein folding is interpreted to typically be limited to a horizontal or vertical axis of the surface, whereas Bends can occur along any axis (2). Folding does not necessary lead to a crease.

### Interaction Styles

Position and shape of flexible displays can be adjusted for various tasks: these displays can be spread about the desk, organized in stacks, or held close for a detailed view. Direct manipulation takes place with the paper display itself: by selecting and pointing using the fingers, or with a digital pen. The grammar of the interaction styles provided by this invention follows that of natural manipulation of paper and other flexible materials that hold information.

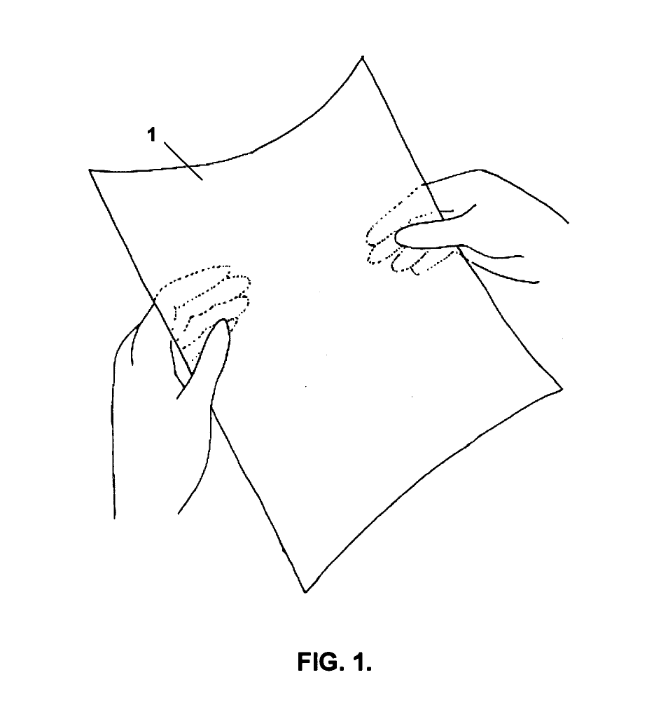

FIGS. 1 through 10 show a set of gestures based on deformations and location of the flexible display(s). These gestures provide the basic units of interaction with the system:

Hold. Users can hold a flexible display with one or two hands during use. The currently held display is the active document (FIG. 1).

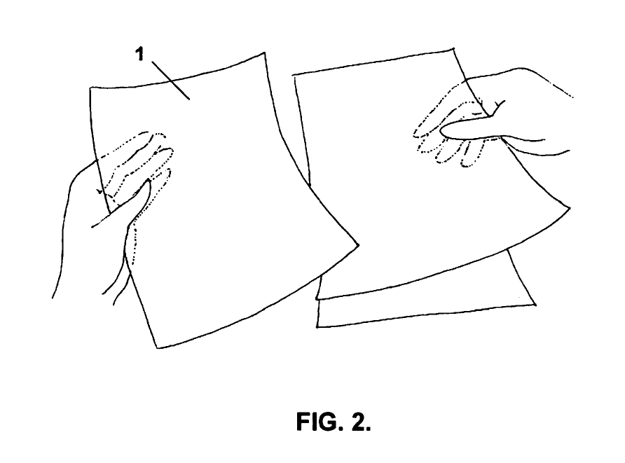

Collocate. FIG. 2 shows the use of spatial arrangement of the flexible display(s) for organizing or rearranging information on said display(s). In one embodiment, collocating multiple flexible displays allows image contents to be automatically spread or enlarged across multiple flexible displays that are collocated.

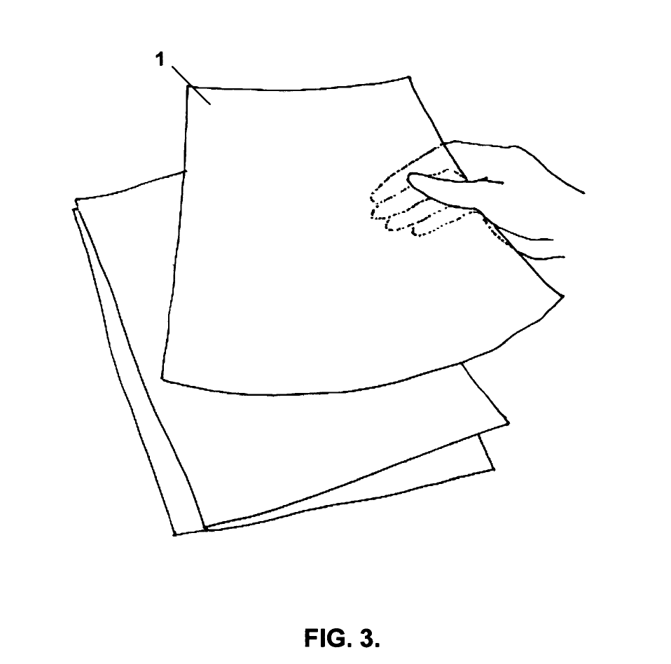

Collate. FIG. 3 shows how users may stack flexible displays, organizing said displays in piles on a desk. Such physical organization is reflected in the digital world by semantically associating or otherwise relating computer content of the displays, be it files, web based or other information, located in a database, on a server, file system or the like, for example, by sorting such computer content according to some property of the physical organization of the displays.

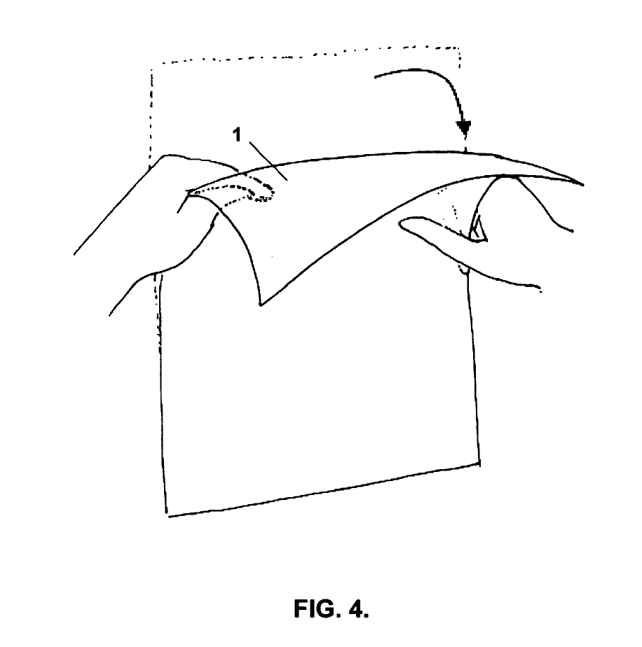

Flip or Turn. FIG. 4 shows how users may flip or turn the flexible display by folding it over its x or y axis, thus revealing the other side of the display. Flipping or turning the flexible display around an axis may reveal information that is stored contiguously to the information displayed on the edge of the screen. Note that this flipping or turning gesture is distinct from that of rotating a rigid display surface, in that the folds that occur in the display in the process of turning or flipping the display around its axes are used in detecting said turn or flip. In single page documents, a flip gesture around the x axis may, in a non-limiting example, scroll the associated page content in the direction opposite to that of the gesture. In this case, the flexible display is flipped around the x axis, such that the bottom of the display is lifted up, then folder over to the top. Here, the associated graphical content scrolls down, thus revealing content below what is currently displayed on the display. The opposite gesture, lifting the top of the display, then folding it over to the bottom of the display, causes content to scroll up, revealing information above what is currently displayed. In the embodiment of multi-page documents, flipping gestures around the x-axis may be used by the application to navigate to the prior or next page of said document, pending the directionality of the gesture. In the embodiment of a web browser, said gesture may he used to navigate to the previous or next page of the browsing history, pending the directionality of the gesture.

In another embodiment, the flexible display is flipped around the y axis, such that the right hand side of the display is folded up, then over to the left. This may cause content to scroll to the right, revealing information to the right of what is currently on display. The opposite gesture, folding the left side of the display up then over to the right, may cause content to scroll to the left, revealing information to the left of what is currently on display. In the embodiment of multi-page documents, flipping gestures around the y-axis may be used by the application to navigate to the prior or next page of said document, pending the directionality of the gesture. In the embodiment of a web browser, said gesture may be used to navigate to the previous or next page of the browsing history, pending the directionality of the gesture.

Fold. Note that wherever the term “Fold” is used it can be substituted for the term “Bend” and vice versa, wherein folding is interpreted to typically be limited to a horizontal or vertical axes of the surface. Where folding a flexible display around either or both its horizontal or vertical axis, either in sequence or simultaneously, serves as a means of input to the software that alters the image content of the document, or affects associated computing functionality (see FIG. 4). As a non-limiting example, this may cause objects displayed in the document to be moved to the center of gravity of the fold, or sorted according to a property displayed in the center of gravity of the fold. As another non-limiting example, following the gravity path of the fold that would exist if water was run through that fold, it may cause objects to be moved from one flexible display to a second flexible display placed underneath it.

Half fold. Where partly folding a flexible display on one side or corner of the Document causes a scroll, or the next or previous page in the associated file content to be displayed (FIG. 4).

Semi-permanent fold. Where the act of folding a flexible display around either its horizontal or vertical axis, or both, in such way that it remains in a semi-permanent folded state after release, serves as input to a computing system. In a non-limiting example, folding causes any contents associated with flexible displays to be digitally archived. In another non-limiting example, the unfolding of the flexible display causes any contents associated with said flexible display to be un-archived and displayed on said flexible display. In another non-limiting example, said flexible display would reduce its power consumption upon a semi-permanent fold, increasing power consumption upon unfold (FIG. 4).

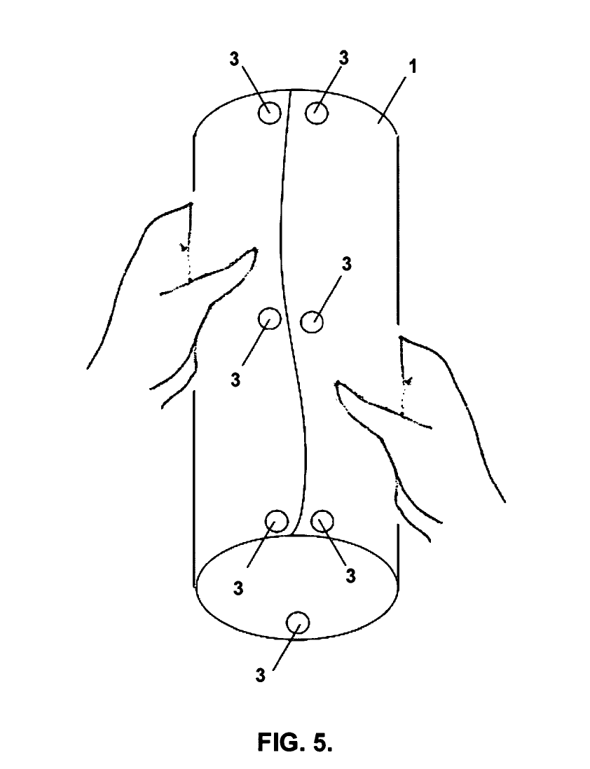

Roll. Where the act of changing the shape of a flexible display such that said shape transitions from planar to cylindrical or vice versa serves as input to a computing system. In a non-limiting example, this causes any contents associated with the flexible display to be digitally archived upon a transition from planar to cylindrical shape (rolling up), and to be un-archived and displayed onto said flexible display upon a transition from cylindrical to planar shape (unrolling). In another non-limiting example, rolling up a display causes it to turn off, while unrolling a display causes it to turn on, or display content (FIG. 5).

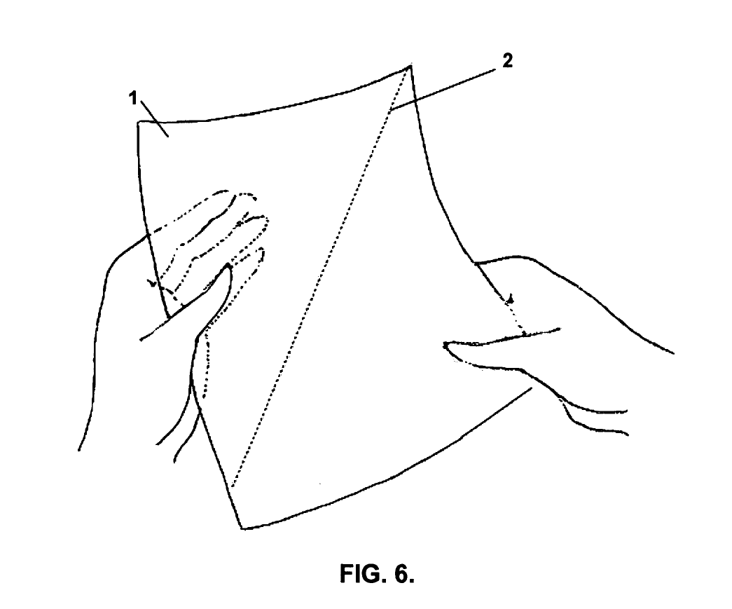

Bend. Where bending a flexible display around any axes serves as input to a computing system. Bend may produce sonic visible or invisible fold line (2) that may be used to select information on said display, for example, to determine a column of data properties in a spreadsheet that should be used for sorting. In another non-limiting example, a bending action causes graphical information to be transformed such that it follows the curvature of the flexible display, either in two or three dimensions. The release of a bending action causes the contents associated with the flexible display to be returned to its original shape. Alternatively, deformations obtained through bending may become permanent upon release of the bending action. (See FIG. 6).

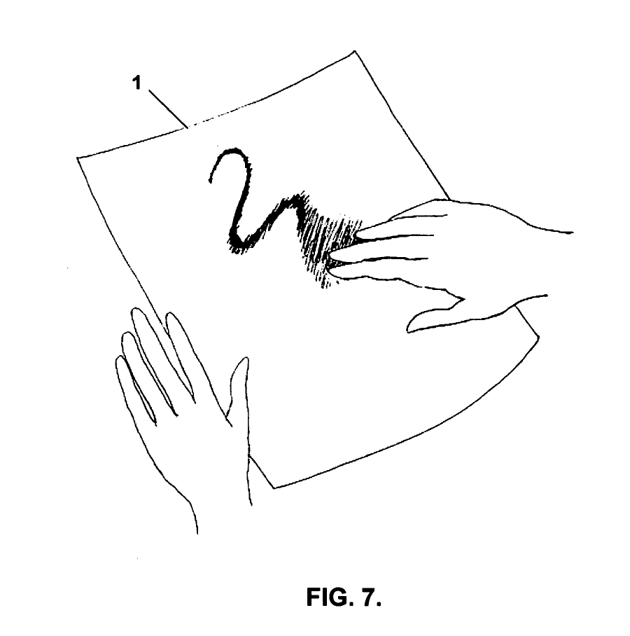

Rub. The rubbing gesture allows users to transfer content between two or more flexible displays, or between a flexible display and a computing peripheral (see FIG. 7). The rubbing gesture is detected by measuring back and forth motion of the hand on the display, typically horizontally. This gesture is typically interpreted such that information from the top display is transferred, that is either copied or moved, to the display(s) or peripheral(s) directly beneath it. However, if the top display is not associated with any content (i.e., is empty) it becomes the destination and the object directly beneath the display becomes the source of the information transfer. In a non-limiting example, if a flexible display is placed top of a printer peripheral, the rubbing gesture would cause its content to be printed on said printer. In another non-limiting example, when an empty flexible display is rubbed on top of a computer screen, the active window on that screen will be transferred to the flexible display such that it displays on said display. When the flexible display contains content, said content is transferred back to the computer screen instead. In a final non-limiting example, when one flexible display is placed on top of another flexible display the rubbing gesture, applied to the top display, causes information to be copied from the top to the bottom display if the top display holds content, and from the bottom to the top display if the top display is empty. In all examples pertaining to the rubbing gesture, information transfer may be limited to those graphical objects that are currently selected on the source display.

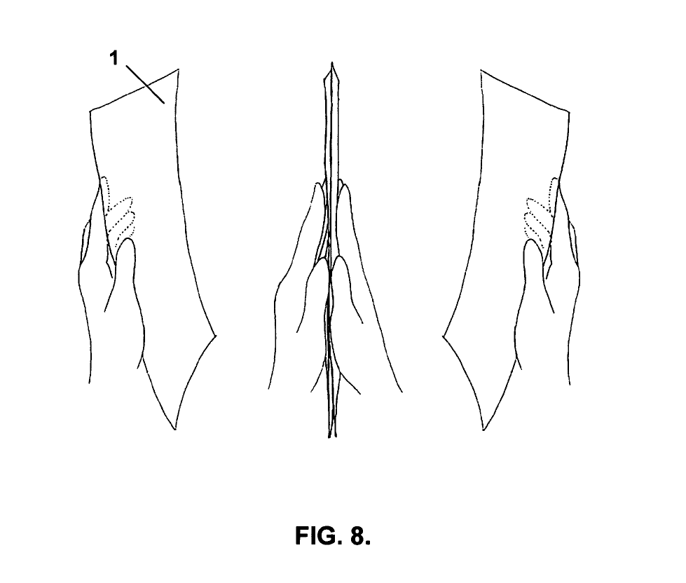

Staple. Like a physical staple linking a set of pages, two or more flexible displays may be placed together such that one impacts the second with a detectable force that is over a set threshold (see FIG. 8). This gesture may be used to clone the information associated with the moving flexible display onto the stationary destination document, given that the destination flexible display is empty. If the destination display is not empty, the action shall be identical to that of the collate gesture.

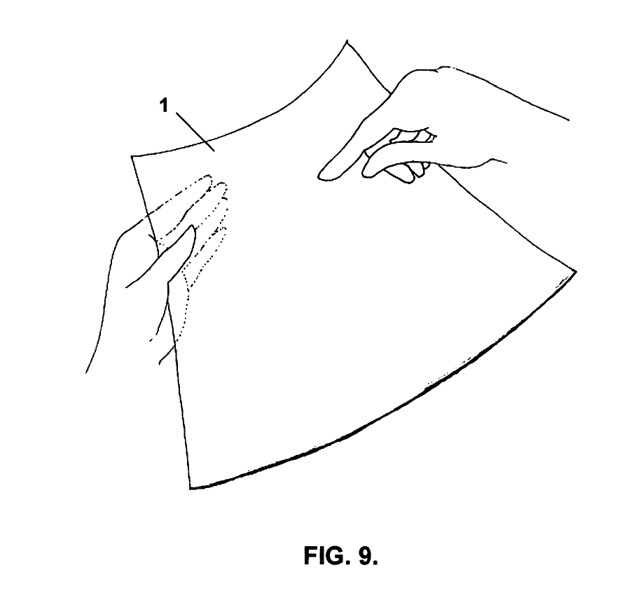

Point. Users can point at the content of a paper window using their fingers or a digital pen (see FIG. 9). Fingers and pens are tracked by either computer vision, accelerometers, or some other means. Tapping the flexible display once performs a single click. A double click is issued by tapping the flexible display twice in rapid succession.

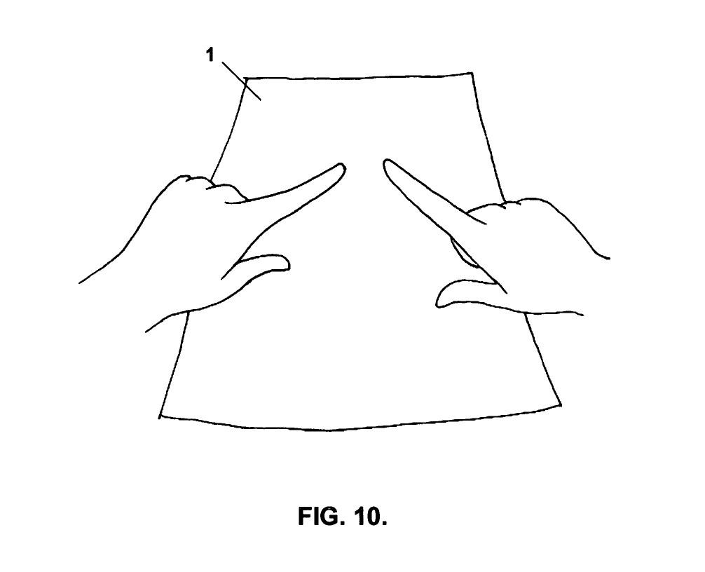

Two-handed Pointing: Two-handed pointing allows users to select disjoint items on a single flexible display, or across multiple flexible displays that are collocated (see FIG. 10).

### Interaction Techniques

We designed a number of techniques for accomplishing basic tasks using our gesture set, according to the following non-limiting examples:

Activate. In GUIs, the active document is selected for editing by clicking on corresponding window. If only one window is associated with one flexible display, the hold gesture can be used to activate that window, making it the window that receives input operations. The flexible display remains active until another flexible display is picked up and held by the user. Although this technique seems quite natural, it may be problematic when using an input device such as the keyboard. For example, a user may be reading from one flexible display while typing in another flexible display. To address this concern, users can bind their keyboard to the active window using a key.

Select. Items on a flexible display can be selected through a one-handed or two-handed pointing gesture. A user opens an item on a page for detailed inspection by pointing at it, and tapping it twice. Two-handed pointing allows parallel use of the hands to select disjoint items on a page. For example, sets of icons can be grouped quickly by placing one finger on the first icon in the set and then tapping one or more icons with the index finger of the other hand. Typically, flexible displays are placed on a flat surface when performing this gesture. Two-handed pointing can also be used to select items using rubber banding techniques. With this technique, any items within the rubber band, bounded by the location of the two finger tips, are selected upon release. Alternatively, objects on a screen can be selected as those located on a foldline or double foldline (2) produced by bends (see FIG. 6).

Copy & Paste. In GUIs, copying and pasting of information is typically performed using four discrete steps: (1) specifying the source, (2) issuing the copy, (3) specifying the destination of the paste and (4) issuing the paste. In flexible displays, these actions can be merged into simple rubbing gestures:

Transfer to flexible display. Computer windows can be transferred to a flexible display by rubbing a blank flexible display onto the computer screen. The window content is transferred to the flexible display upon peeling the flexible display off the computer screen. The process is reversed when transferring a document displayed on a flexible display back to the computer screen.

Copy Between Displays. Users can copy content from one flexible display to the next. This is achieved by placing a flexible display on top of a blank display. The content of the source page is transferred by rubbing it onto the blank display. If prior selections exist on the source page, only highlighted items are transferred.

Scroll. Users can scroll through content of a flexible display in discrete units, or pages. Scrolling action is initiated by half-folding, or folding then flipping the flexible displays around its horizontal or vertical axis with a flip or fold gesture. In a non-limiting example, this causes the next page in the associated content to be displayed on the back side of the flexible display. Users can scroll back by reversing the flip.

Browse. Flips or folds around the horizontal or vertical axis may also be used to specify back and forward actions that are application specific. For example, when browsing the web, a left flip may cause the previous page to be loaded. To return to the current page, users would issue a right flip. The use of spatially orthogonal flips allows users to scroll and navigate a document independently.

Views. The staple gesture can be used to generate parallel copies of a document on multiple flexible displays. Users can open a new view into the same document space by issuing a staple gesture impacting a blank display with a source display. This, for example, allows users to edit disjoint parts of the document simultaneously using two separate flexible displays. Alternatively, users can display multiple pages in a document simultaneously by placing a blank flexible display beside a source flexible display, thus enlarging the view according to the collocate gesture. Rubbing across both displays causes the system to display the next page of the source document onto the blank flexible display that is beside it.

Resize/Scale. Documents projected on a flexible display can be scaled using one of two techniques. Firstly, the content of a display can be zoomed within the document. Secondly, users can transfer the source material to a flexible display with a larger size. This is achieved by rubbing the source display onto a larger display. Upon transfer, the content automatically resines to fit the larger format.

Share. Collocated users often share information by entailing or printing out documents. We implemented two ways of sharing: slave and copy. When slaving a document, a user issues a stapling gesture to clone the source onto a blank display. In the second technique, the source is copied to a blank display using the rubbing gesture, then handed to the group member.

Open. Users can use flexible displays, or other objects, including computer peripherals such as scanners and copiers as digital stationary. Stationary pages are blank flexible displays that only display a set of application icons. Users can open a new document on the flexible display by tapping an application icon. Users may retrieve content from a scanner or email appliance by rubbing it onto said scanner or appliance. Users may also put the display or associated computing resources in a state of reduced energy use through a roil or semi-permanent fold gesture, where said condition is reversed upon unrolling or unfolding said display.

Save. A document is saved by performing the rubbing gesture on a single flexible display, typically while it is placed on a surface.

Close, Content displayed on a flexible display may be closed by transferring its contents to a desktop computer using a rubbing gesture. Content may be erased by crumbling or shaking the flexible display.

### Apparatus of the Invention

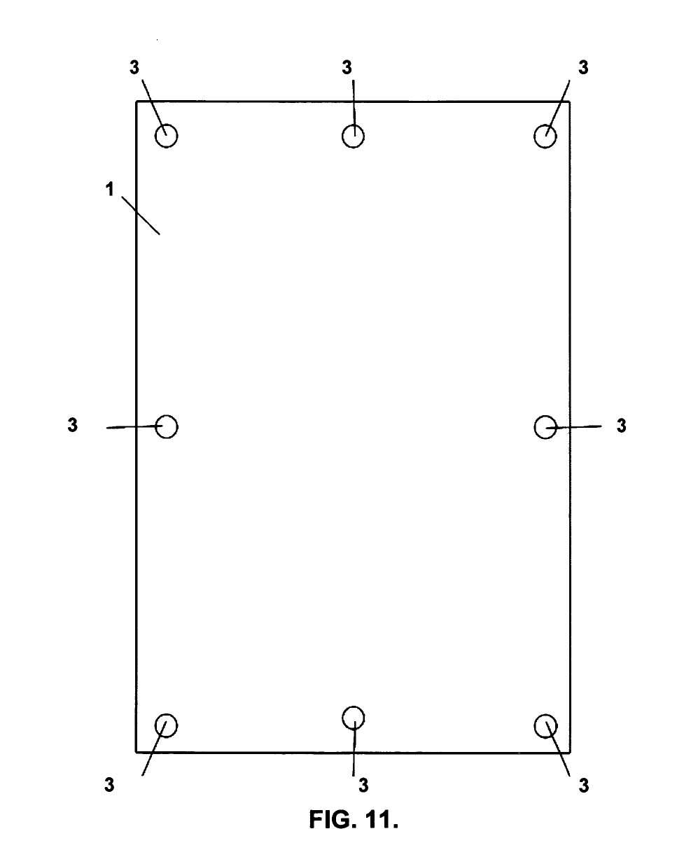

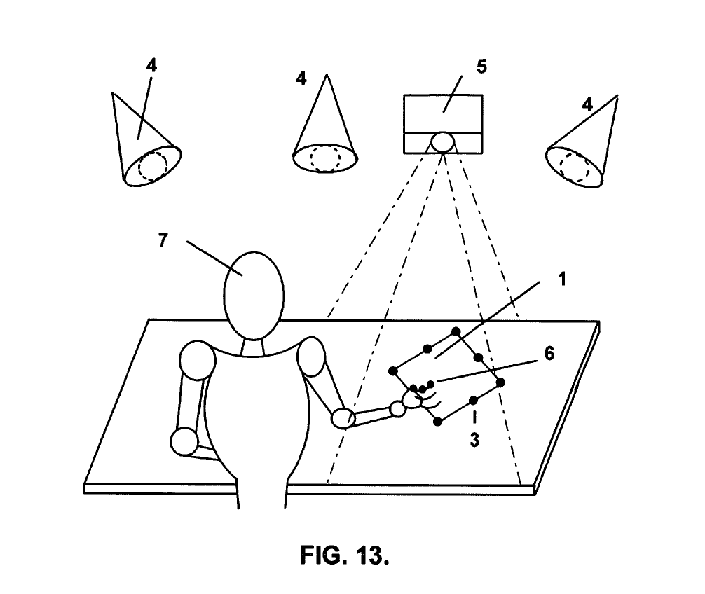

In one embodiment of the invention, a real piece of flexible, curved or three-dimensional material, such as a cardboard model, piece of paper, textile or human skin may be tracked using computer vision, modeled, texture mapped and then projected back upon the object. Alternatively, the computer vision methods may simply be used to track the shape, orientation and location of a flexible display that does not require the projection component. This in effect implements a projected two-sided flexible display surface that follows the movement, shape and curves of any object in six degrees of freedom. An overview of the elements required for such embodiment of the flexible display (1) is provided in FIGS. 10 and 11. In this non-limiting example, the surface is augmented with infrared (IR) reflective marker dots (3). FIG. 13 shows the elements of the capture and projection system, where the fingers (6) of the user (7) are tracked by affixing three or more IR marker dots to the digit. A digital projection unit (5) allows for projection of the image onto the scene, and a set of infrared or motion capturing cameras (4) allows tracking of the shape orientation and location of the sheets of paper. The following section discusses each of the above apparatus elements, illustrating their relationship to other objects in this embodiment of the system. This example does not withstand other possible embodiments of the apparatus, which include accelerometers embedded in lieu of the marker dots, and mounted on flexible displays. In such embodiment, the wireless accelerometers report acceleration of the marked positions of the material in three dimensions to a host computer so as to determine their absolute or relative location.

In one embodiment, the computer vision component uses a Vicon (23) tracker or equivalent computer vision system that can capture three dimensional motion data of retro-reflective markers mounted on the material. Our setup consists of 12 cameras (4) that surround the user's work environment, capturing three dimensional movement of all retro-reflective markers (3) within a workspace of 20′×10′ (see FIG. 13). The system then uses the Vicon data to reconstruct a complete three-dimensional representation that maps the shape, location and orientation of each flexible display surface in the scene.

In this embodiment, an initial process of modeling the flexible display is required before obtaining the marker data. First, a Range of Motion (ROM) trial is captured that describes typical movements of the flexible display through the environment. This data is used to reconstruct a three dimensional model that represents the flexible display. Vicon software calibrates the ROM trial to the model and uses it to understand the movements of the flexible display material during a real-time capture, effectively mapping each marker dot on the surface to a corresponding location on the model of the flexible display in memory. To obtain marker data, we modified sample code that is available as part of Vicon's Real Time Development Kit (23).

As said, each flexible display surface within the workspace is augmented with IR reflective markers, accelerometers and/or optic fibres that allow shape, deformation, orientation and location of said surface to be computed. In the embodiment of a paper sheet, or paper-shaped flexible display surface, the markers are affixed to form an eight point grid (see FIGS. 10 and 11). In the embodiment where computer vision is used, a graphics engine interfaces with the Vicon server, which streams marker data to our modeling component. In the embodiment where accelerometers are used, coordinates or relative coordinates of the markers are computed from the acceleration of said markers, and provided to our modeling component. The modeling component subsequently constructs a three-dimensional model in OpenGL of each flexible display surface that is tracked by the system. The center point of the flexible display surface is determined by averaging between the markers on said surface. Bezier curve analysis of marker locations is used to construct a fluid model of the flexible display surface shape, where Bezier control points correspond with the location of markers on the display surface. Subsequent analysis of the movement of said surface is used to detect the various gestures.

Applications that provide content to the flexible displays run on an associated computer. In cases where the flexible display surface consists of a polymer flexible display capable of displaying data without projection, application windows are simply transferred and displayed on said display. In the case of a projected flexible display, application windows are first rendered off-screen into the OpenGL graphics engine. The graphics engine performs real-time screen captures, and maps a computer image to the three dimensional OpenGL model of the display surface. The digital projector then projects an inverse camera view back onto the flexible display surface. Back projecting the transformed OpenGL model automatically corrects for any skew caused by the shape of the flexible display surface, effective synchronizing the two. The graphics engine similarly models fingers and pens in the environment, posting this information to the off-screen window for processing as cursor movements. Alternatively, input from pens, fingers or other input devices can be obtained through other methods known in the art. In this non-limiting example, fingers (6) of the user (7) are tracked by augmenting them with 3 IR reflective markers (3). Sensors are placed evenly from the tip of the finger up to the base knuckle. Pens are tracked similarly throughout the environment. The intersection of a finger or pen with a flexible display surface is calculated using planar geometry. When the pen or finger is sufficiently close, its tip is projected onto the plane of the flexible display surface. The position of the tip is then related to the length and width of the display. The x and y position of the point on the display (1) is calculated using simple trigonometry. When the pen or finger touches the display, the input device is engaged.

### Imaging

In the embodiment of a projected flexible display, computer images or windows are rendered onto the paper by a digital projector (5) positioned above the workspace. The projector is placed such that it allows a clear line of sight with the flexible display surface between zero and forty-five degrees of visual angle. Using one projector introduces a set of tradeoffs. For example, positioning the projector close to the scene improves the image quality but reduces the overall usable space, and vice versa. Alternatively a set of multiple projectors can be used to render onto the flexible display surface as it travels throughout the environment of the user.

Initially, a calibration procedure is required to pair the physical position of the flexible display surface and the digital output of the projector. This is accomplished by adjusting the position, rotation, and size of the projector output until it matches the dimensions of the physical display surface.

### Gesture Analysis

In the following section, the term “marker” is interchangeable with the term “accelerometer”. Understanding the physical motion of paper and other materials in the system requires a combination of approaches. For gestures such as stapling, it is relatively easy to recognize when two flexible displays are rapidly moved towards each other. However, flipping requires knowledge of a flexible display surface's prior state. To recognize this event, the z location of markers at the top and bottom of the page is tracked. During a vertical or horizontal half-rotation, the relative location on the z dimension is exchanged between markers. The movement of the markers is compared to their previous position to determine the direction of the flip, fold or bend.

To detect more advanced gestures, like rubbing, marker data is recorded over multiple trials and then isolated in the data. Once located, the gesture is normalized and is used to calculate a distance vector for each component of the fingertip's movement. The system uses this distance vector to establish a confidence value. If this value passes a predetermined threshold the system recognizes the gesture, and if such gesture occurs near the display surface, a rubbing event is issued to the application.

### EXAMPLES

### Example 1

### Photo Collage

There are many usage scenarios that would benefit from the functionality provided by the invention. One such non-limiting example is the selection of photos for printout from a digital photo database containing raw footage. Our design was inspired by the use of contact sheets by professional photographers. Users can compose a photo collage using two flexible displays, selecting a photo on one overview display and then rubbing it onto the second display with a rubbing gesture. This scenario shows the use of flexible display input as a focus and context technique, with one display providing a thumbnail overview of the database, and the other display offering a more detailed view.

Users can select thumbnails by pointing at the source page, or by selecting rows through producing a foldline with a bend gesture. By crossing two fold lines, a single photo or object may be selected. Thumbnails that appear rotated can be turned using a simple pivoting action of the index finger. After selection, thumbnails are transferred to the destination page through a rubbing gesture. After the copy, thumbnails may resize to fit the destination page. When done, the content of the destination flexible display can be printed by performing a rubbing gesture onto a printer. The printer location is tracked similarly to that of the flexible display, and is known to the system. Gestures supported by the invention can also be used to edit photos prior to selection. For example, photos are cropped by selecting part of the image with a two-handed gesture, and then rubbing the selection onto a destination flexible display. Photos can be enlarged by rubbing them onto a larger flexible display.

### Example 2

### Flexible Cardboard Game

In this non-limiting embodiment, the invention is used to implement a computer game that displays its graphic animations onto physical game board pieces. Said pieces may consist of cardboard that is tracked and projected upon using the apparatus described in this invention, or electronic paper, LCD, e-ink, OLED or other forms of thin, or thin-film displays. The well-known board game Settlers of Catan consists of a game board design in which hexagonal pieces with printed functionality can be placed differently in each game, allowing for a game board that is different each game. Each hexagonal piece, or hex, represents a raw material or good that can be used to build roads or settlements, which is the purpose of the game. In this application, each hex is replaced by a flexible display of the same shape, the position and orientation of which is tracked through the hexes such that a board is formed. A computer algorithm then renders the functionality onto each flexible display hex. This is done through a computer algorithm that calculates and randomizes the board design each time, but within and according to the rules of the game. The graphics on the hexes is animated with computer graphics that track and represent the state of the game. All physical objects in the game are tracked by the apparatus of our invention and can potentially be used as display surfaces. For example, when a user rolls a die, the outcome of said roll is known to the game. Alternatively, the system may roll the die for the user, representing the outcome on a cube-shaped flexible display that represents the cast die. In the game, the number provided by said die indicates the hex that is to produce goods for the users. As an example of an animation presented on a hex during this state of the game, when the hex indicates woodland, a lumberjack may be animated to walk onto the hex to cut a tree, thus providing the wood resource to a user. Similarly, city and road objects may be animated with wagons and humans after they are placed onto the hex board elements. Hex elements that represent ports or seas may be animated with ships that move goods from port to port. Animations may trigger behavior in the game, making the game more challenging. For example, a city or port may explode, requiring the user to take action, such as rebuild the city or port. Or a resource may be depleted, which is represented by a woodland hex slowly turning into a meadow hex, and a meadow hex slowly turning into a desert hex that is unproductive. Climate may be simulated, allowing users to play the game under different seasonal circumstances, thus affecting their constraints. For example, during winters, ports may not be in use. This invention allows the functionality of pc-based or online computer games known in the art, such as Simcity, The Sims, World of Warcraft, or Everquest to be merged with that of physical board game elements.

### Example 3

### 3D Flexible Display Objects.

In this non-limiting embodiment, the invention is used to provide display on any three dimensional object, such that it allows animation or graphics rendering on said three dimensional object. For example, the invention may be used to implement a rapid prototyping environment for the design of electronic appliance user interfaces, such as, for example, but not limited to, the Apple iPod. One element of such embodiment is a three dimensional model of the appliance, made out of card board, Styrofoam, or the like, and either tracked and projected upon using the apparatus of this invention or coated with electronic paper, LCD, e-ink, OLED or other forms of thin, or thin-film displays, such that the shapes and curvatures of the appliance are followed. Another flexible display apparatus described in this invention. Rather than setting up the board according to the rules of the game, users need just lay out the flexible display surface acts as a palette on which user interface elements such as displays and dials are displayed. These user interface elements can be selected and picked up by the user by tapping its corresponding location on the palette display. Subsequent tapping on the appliance model places the selected user interface element onto the appliance's flexible display surface. User interface elements may be connected or associated with each other using a pen or finger gesture on the surface of the model. For example, a dial user interface element may be connected to a movie user interface element on the model, such that said dial, when activated, causes a scroll through said movie. After organizing elements on the surface, subsequent tapping of the user onto the model may actuate functionality of the appliance, for example, a play button may cause the device to produce sound or play a video on its movie user interface element. This allows designers to easily experiment with various interaction styles and layout of interaction elements such as buttons and menus on the appliance design prior to manufacturing. In another embodiment, the above model is a three-dimensional architectural model that represents some building design. Here, each element of the architectural model consists of a flexible display surface. For example, one flexible display surface may be shaped as a wall element, while another flexible display surface may be shaped as a roof element that are physically placed together to form the larger architectural model. Another flexible display surface acts as a palette on which the user can select colors and materials. These can be pasted onto the flexible display elements of the architectural model using any of the discussed interaction techniques. Once pasted, said elements of the architectural model reflect and simulate materials or colors to be used in construction of the real building. As per Example 2, the flexible display architectural model can be animated such that living or physical conditions such as seasons or wear and tear can be simulated. In another embodiment, the flexible display model represents a product packaging. Here, the palette containing various graphical elements that can be placed on the product packaging, for example, to determine the positioning of typographical elements on the product. By extension of this example, product packaging may itself contain or consist of one or multiple flexible display surfaces, such that the product packaging can be animated or used to reflect some computer functionality, including but not limited to online content, messages, RSS feeds, animations, TV shows, newscasts, games and the like. As a non-limiting example, users may tap the surface of a soft drink or food container with an embedded flexible display surface to play a commercial advertisement or TV show on said container, or to check electronic messages. Users may rotate the container to scroll through content on its display, or use a rub gesture to scroll through content. In another embodiment, the product packaging is itself used as a pointing device, that allows users to control a remote computer system.

### Interaction Techniques

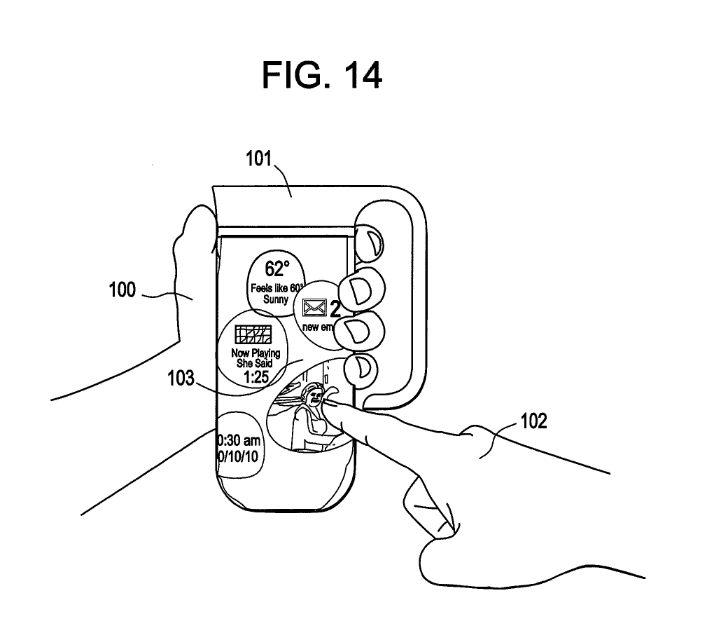

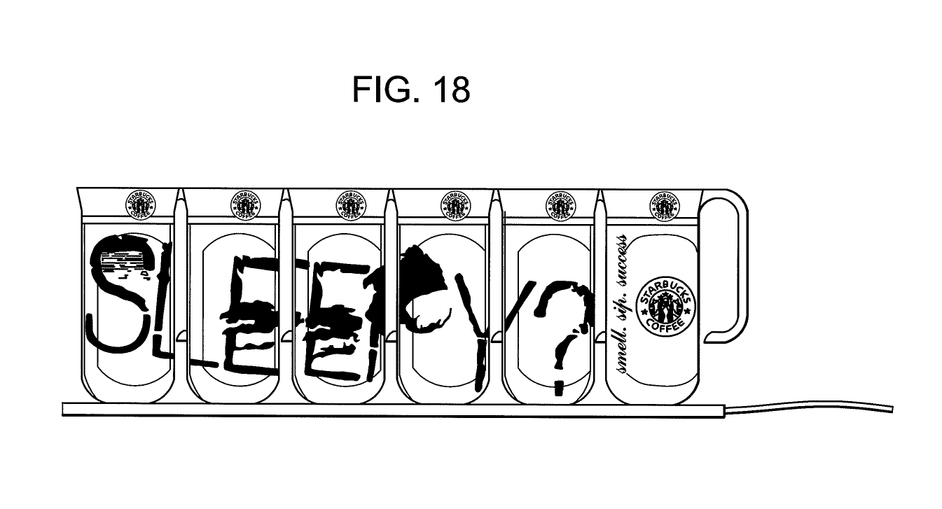

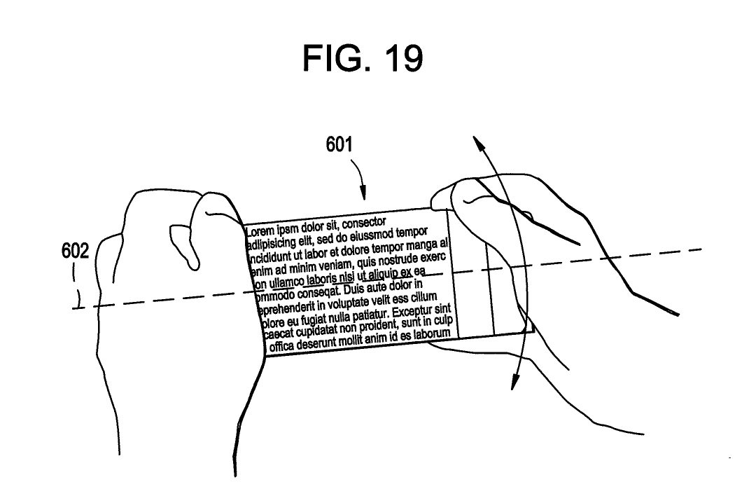

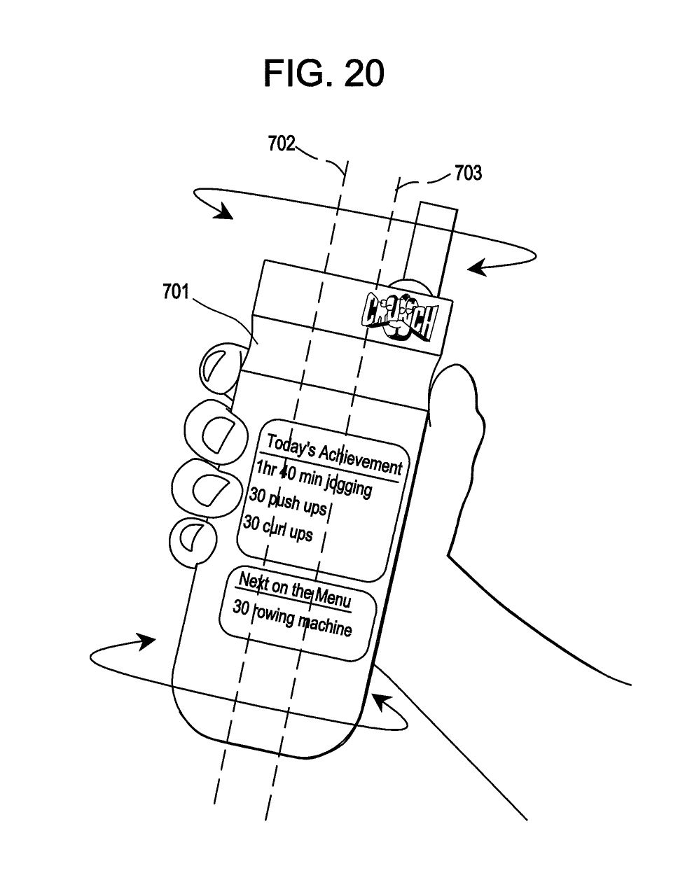

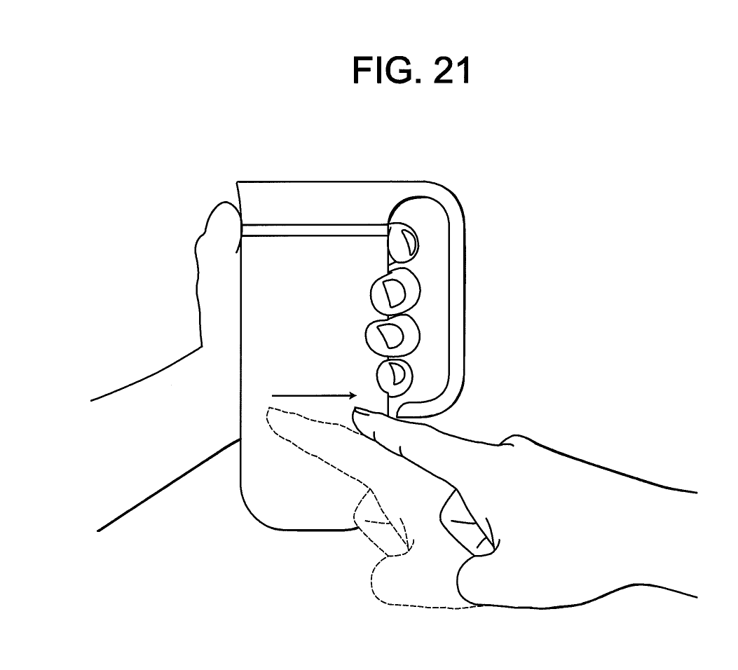

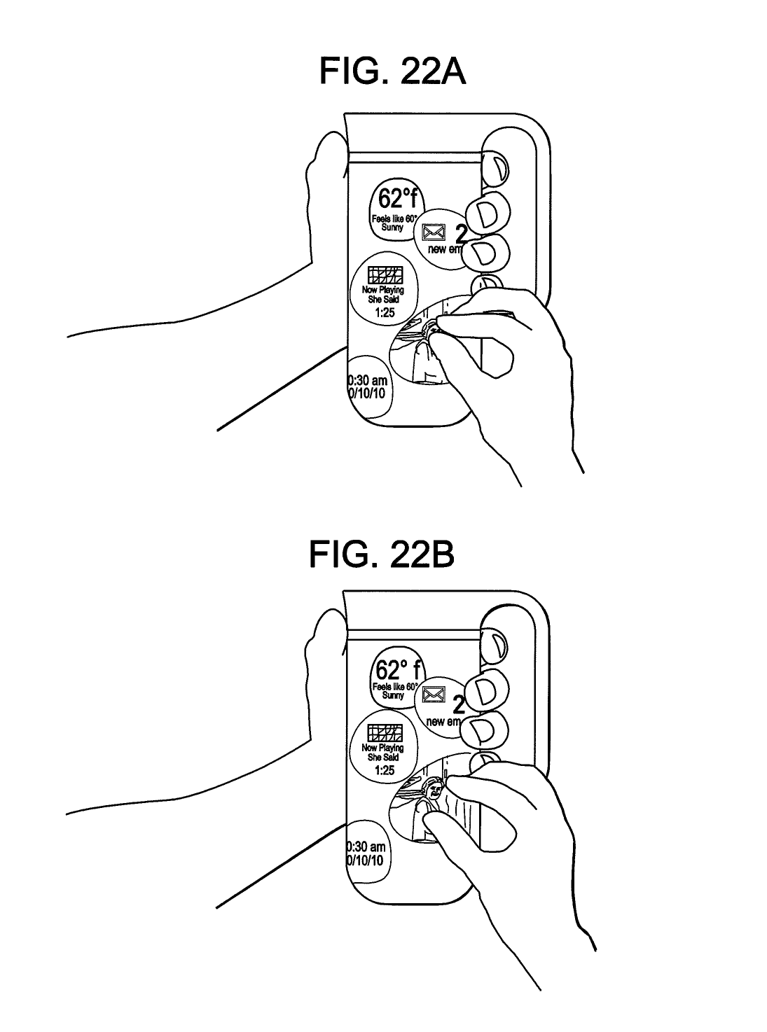

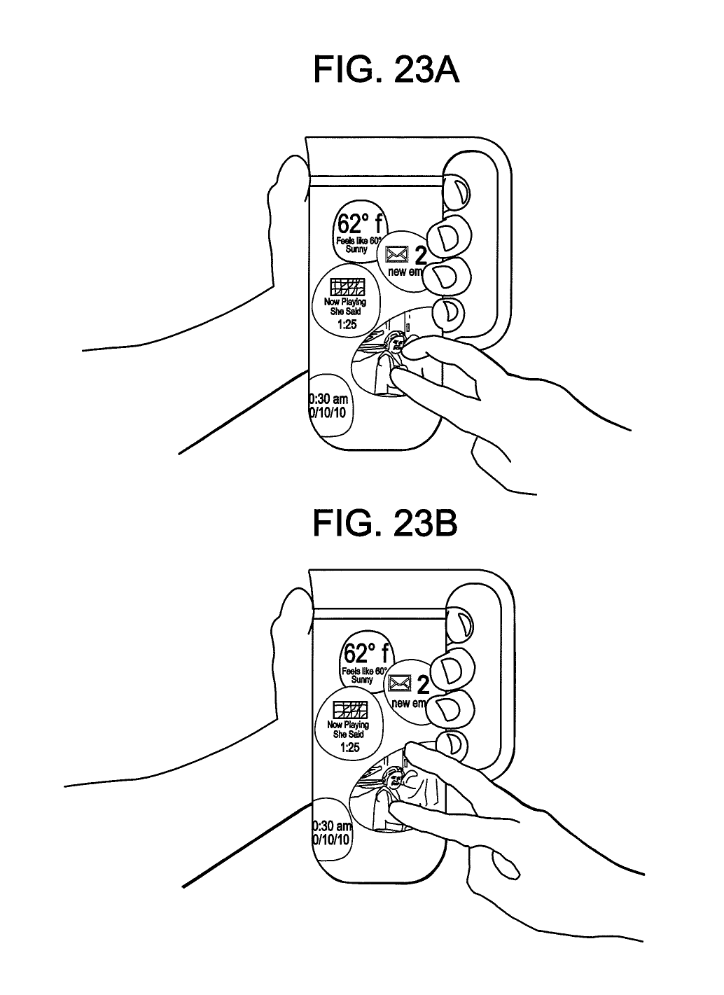

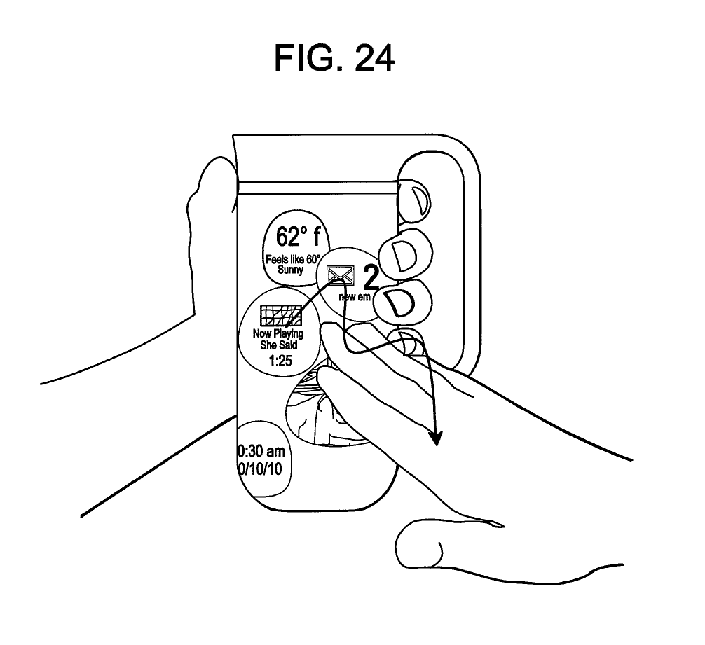

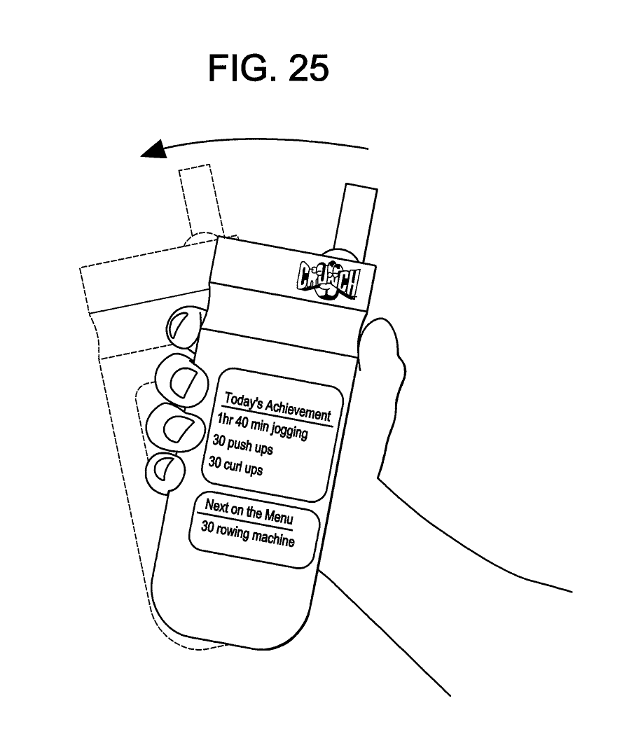

FIGS. 14-25 show a set of interaction techniques for curved displays and/or an interactive beverage or food container. Any combination of these interaction techniques may be used to sense when to display or activate a particular function or action. These input techniques provide the basic units of interaction with the system:
1. Hold. As shown in FIG. 14, users can hold the device with one or two hands. In one embodiment this serves to activate the device from sleep. When the device is held with one hand, typically, but not limited to, the non-dominant hand, the other hand may still be used to perform any and all of the remaining interaction techniques in the below list. When a hold is detected, input by fingers from the holding hand is suppressed so as not to interfere with the interpretation of input by fingers of the other hand, or by the thumb of the holding hand.
2. Collocate and collate/stack. FIG. 18 shows the use of spatial arrangement of multiple devices for organizing or rearranging information on their displays. In one embodiment, collocating multiple devices horizontally, or collating multiple devices vertically (stacking), allows image contents to be automatically spread or enlarged across multiple device screens. Any interaction techniques now operate across the entire surface of collocated or collated display screens, and graphic elements may be moved across the boundaries of screens through of the use of the appropriate interaction technique.
3. Turn or Rotate. FIG. 19 shows how users may rotate or turn the device around its longitudinal axis, thus revealing the other side of the device's display. In one embodiment, rotating the device around an axis may reveal information that is stored contiguously to the information displayed on the edge of said display. Note that this rotation is distinct from that of flipping a flat rigid display surface found in, e.g., PDAs, in that parts of the display that are hidden from view are revealed continuously throughout the process of turning or rotating. Although rotation may, in a non-limiting example, be similar to a scroll, because the entire display moves, graphics do not actually need to move on the display. In one non-limiting example, information is drawn contiguous to the information displayed on the part of the display visible to the user on parts of the display that are becoming visible to the user, overwriting information that is already displayed on said parts that are becoming visible. After a 720 degree turn this means all information on the display will be overwritten. The opposite rotation causes content to be revealed in the opposite direction in the associated document or application. In another embodiment, said scroll is initiated with a scroll rate that is relative to the rotation of the device away from some rest state. If the device is held with its longitudinal axis pointing upright, a rotation causes information to be revealed that is to the right or left of the currently displayed information, respectively. To reveal information above or below the display in such condition may require the use of a swipe. If the device is held with its longitudinal axis horizontally (this typically requires two hands holding the device at both extremities, see FIG. 19), information is revealed above or below the currently displayed information, respectively. To reveal information to the right or left of the display in such condition may require the use of a swipe. When a graphic object is selected with a finger on the display, said object may stay stationary, while the rotation may only act upon the background graphics. This allows objects to be moved across large documents with relative ease.
4. Swirl. FIG. 20 shows how the device may be swirled around an axis 702 that is non-concentrical but parallel to the longitudinal axis 703 of said device. This may occur while said axis is horizontal or vertical. In the latter case two hands typically hold the device, one at each extremity. In one embodiment, swirling the device may reveal information that is stored contiguously to the information displayed on the edge of said display (scroll). In a non-limiting example, this scrolls the associated page content in the direction opposite to that of the direction of rotation. For example, when the device is held with its longitudinal axis pointing upright, swirling the device clockwise causes information to the right of the currently displayed information to be rendered. Swirling the device counterclockwise causes information to the left of the display area currently visible to the user to move to the right, and into the area visible to the user. Similarly, when the longitudinal axis is horizontally aligned, swirling such that the flow of motion of the display surface itself is downwards causes information rendered above the area currently visible to the user to move down and into the area visible to the user, while swirling up causes the opposite effect. A short swirl may serve as an impulse for graphics that operate with an associated physics model, causing the displayed information to move in the direction of the short swirl with an acceleration related to the impulse of said swirl. When a graphic object is selected with a finger held down on the display, said object may stay stationary, and the swirl may only act upon the background graphics. This allows objects to be moved across large documents with relative ease.
5. Non-planar Swipe. FIG. 21 shows the swipe technique, which involves moving one or more fingers along the surface of the display across a set minimum distance and with a set minimum velocity. Swipe can be recognized in any direction of movement. In one embodiment it will be limited to horizontal or vertical movement recognition only. This swipe occurs on a non-flat screen, and thus requires the finger(s) to follow a three-dimensional trajectory relative to the normal plane at the point of contact. Swipe may occur while the longitudinal axis is horizontal or vertical. In the latter case, two hands typically hold the device, one at each extremity. In one embodiment, performing a swipe on the device may reveal information that is stored contiguously to the information displayed on the edge of said display. In a non-limiting example, this scrolls the associated page content in the direction of the swipe. For example, when the device is held with its longitudinal axis pointing upright, a swipe to the right causes information to the left of the currently displayed information to be revealed on the display area visible to the user. A swipe to the left causes information to the right of the currently displayed information to be revealed on the display area visible to the user. Similarly, when the longitudinal axis is horizontally aligned, swiping down reveals information in the document or application that are above the top edge of the graphics display, while swiping up causes information below the edge of the current graphics display visible to the user to be shown. A swipe may serve as an impulse for graphics that operate with an associated physics model, causing the displayed information to move in the direction to the swipe with an impulse related to that of said swipe. When a graphical object is selected on the display with a finger, said object may stay stationary, and the swipe may only act upon the background graphics. In a non-limiting example, this allows graphic objects to be moved across large documents with relative ease. If the swipe crosses any part of the selected object, this will instead cause that object to move using a physics motion model accelerated with the swipe impulse. In this case, background graphics do not move.
6. Non planar Strip Swipe. A strip swipe is a swipe that occurs on the top or bottom extremities of the display, seen from the position of the longitudinal axis of the device being held upright, or just above or below the display surface. Such swipe is identical in behavior to the non-planar swipe, however, in this non-limiting example it serves to scroll a menu bar displayed on the top or bottom of the display, similar to a ticker. In this non-limiting example, menu selections are made by touching the menu on the display, or by touching the strip above or below the menu on the display. The menu displays its items upon a touch of the finger. The user then touches the desired menu item, which causes it to be selected. Alternatively, after the menu is displayed, the finger can slide down the menu to the desired item and then be released, causing the item to be selected. In another non-limiting example, the strip swipe is used to operate a traditional scroll bar, which causes information on the display to scroll opposite to the direction of movement.
7. Two-finger Non-planar Pinch. FIGS. 22A and 22B show the two-finger non-planar pinch, which can be conducted with one or two hands. When two fingers are placed on the screen, their distance becomes a means of input. In this non-limiting example, if the distance becomes smaller, a map application might zoom out, whereas if the distance becomes larger, it might zoom in. This pinch occurs on a non-flat screen, and thus requires the finger(s) to follow a three-dimensional trajectory relative to the normal plane at the point of contact.
8. Three-finger Non-planar Pinch. The three-finger pinch is similar to the two-finger pinch with the exception that three fingers need to be placed on the surface of the display. In this non-limiting example, the three-finger pinch is used to select objects on the display.
9. Pin and swipe. FIGS. 23A and 23B show a two-fingered and optionally two-handed input technique in which one finger is placed and held on the display, while the other performs a swipe gesture. This may cause, in a non-limiting example, content to zoom rather than scroll, the metaphor being that the graphics information is held in place by the finger that is held down. This gesture differs from a pinch gesture in that only one finger moves relative to the other, which is held in place.
10. Point and Drag. Pointing action is the placing of a finger on the display, which causes the device to track the position of said finger on said display. When the finger is released without moving, this results in a click action, which may in this non-limiting example serve to select on-screen content, move a text insertion point, or push an on-screen button. When the finger is moved without release, within a distance or velocity that is below the threshold for a swipe, this causes the system to execute a drag. In this non-limiting example, a drag moves a graphical object underneath the finger upon touching the display to track the location of the finger. Upon release, the object is released from further movement. Pointing may occur with multiple fingers, and interpretation may depend on the context of the application.
11. Tap. FIG. 14 shows a user tapping the curved display surface. The number of taps within a set time period may serve as input to the device.
12. Deform. In one embodiment, the surface of the container may deform upon depressing the finger. Upon release this causes a clicking action of which the location can be triangulated using three contact microphones on the surface of the device. This may serve as input to a computer program running on said device.
13. Button Press. The device surface area not occupied by a screen may contain buttons for the purpose of input to a computer program running on said device. Said buttons can be depressed or released to serve as input.
14. Rub. FIG. 24 shows a rubbing gesture, which is performed by moving the finger or hand back and forth on the device in a dampened sinusoidal spatial pattern. In a non-limiting example, this gesture serves to erase graphics content on the screen, or cancel a selection. In another embodiment, rub is used to save a document.
15. Type. In one embodiment, the display may have a keyboard associated through some connection. Keyboard input is provided to the current software program running on the device. In another embodiment, said keyboard is a soft keyboard displayed on the surface of the non-planar display. Said keyboard may feature varying layouts. Users can activate keys by typing on the software keyboard, or select words by swiping between keys on the screen that compose said words, according to the Shark method of input [1]. Said keyboards differ from other keyboards in that they are not laid out on a flat surface, but follow the shape of the display.
16. Dial. A dial may be disposed on the circular area at the extremities of a cylindrically curved display surface. The preferred embodiment of this dial is a trackpad. A rotational gesture of the finger on may control the dial action. In one non-limiting example, said action serves to scroll through information on the screen in a way similar to the example provided with the rotate gesture. In another, this serves to scroll through a menu in a way similar to the example provided with the strip swipe.
17. Tilt. FIG. 25 shows how tilting the device can be used as an input technique for moving content. In a non-limiting example, tilt angle controls playback speed of a video.
18. Flick or Toss. By rapidly tilting, stopping and optionally returning to the original orientation, users can manipulate on-screen information. In a non-limiting example, users can cause a page turn to execute using this gesture, or information to be copied to an adjacent device.
   (Note: The remaining interaction techniques are spec he embodiment of a food or beverage container)
19. Rest. The act of placing the container resting on a surface, without being touched, and with all fluid content remaining level, may serve as input. In this non-limiting example, this is used to sleep the device after a set time threshold. In another, it can serve to communicate the fluid level or volume of fluid at rest inside the container.
20. Drinking, Filling and Fluid Level. The act of bringing the container to the mouth, drinking a beverage from the container, filling the container, or altering the level of the fluid in it, can serve as input. In this non-limiting example, this can serve to communicate your online status to others, setting it to drinking, and communicating the type of beverage being consumed. When users stop drinking, their online status returns to its default state. In another non-limiting example, the level of the beverage can also be reported as an online status, or on the screen of the device. The level can also serve as a means to control information on the screen.
21. Lid status: open or closed. Opening and closing the container can function as input. In this non-limiting example, such input serves to cause a graphics effect on the screen and/or sound effect. For example, opening the container may cause a jack to spring out of an on-screen box. In another non-limiting example, the lid status may serve as an alarm, informing the user when the lid is not properly closed and fluid may be spilling.
22. Touch/Pick up. Touching the container at any point of contact, and/or picking up the container from a resting state may serve as input. In this non-limiting example, it serves to wake the system from sleep. In another, it serves to set your online status to “online” or “available”.
23. Shake. Shaking the container may serve as input. In a non-limiting example, it serves to prowess to the next step in a recipe for preparing drinks, if said prior step involved stirring.
24. Place. Placing the beverage container in a specific location, such as its dock or in a refilling station may serve as input. In a non-limiting example, the dock or station connects to the device to charge its batteries, and connects to its wired or wireless network connector to transfer information.
25. Multi-Device Bump. Physically bumping two containers may connect their networks and serve to communicate information between said containers. In this non-limiting example, the containers exchange information on beverage content, recipes or contact information upon physically bumping two containers. In another non-limiting example, this act can serve to connect the users via social networking software, such as befriending them on Facebook.
26. Multi-Device Pour. One container can be held over another and tilted. Such action can serve to transfer or copy information from the top container to the bottom container. In this non-limiting example, the currently selected file or object is transferred from the first container to the second container.
27. Rumble. To shake the container with the specific purpose of charging it through body motion.
28. Fingerprint scanning. To place a fingerprint onto an area of the container on which a finger print reader is disposed, with the purpose of authenticating the user or usage.
29. Face detection. To identify the face of the user using a camera disposed on the container so as to authenticate said user or usage of said container.

### Operations

The above interaction techniques can be applied to any operation executed by the computer associated with or disposed on said electronic food or beverage container, or said curved display. Such operations may affect the state of the curved display in a real-time fashion. The following list provides a non-limiting example of ways in which the interaction techniques may be combined to achieve a desired operation. Such combinations constitute a limited local form of context awareness, in that the computational result from an interaction technique may depend on the outcome of another set of interaction techniques synchronized through co-occurrence. In particular, any of the above interaction techniques may serve to operate a selection of the following non-limiting list of computer actions:
1. Activate. To wake the computer from sleep, activate the display, or computation, or window on display.
2. Select. To select a graphic object on the screen.
3. Copy Paste. To copy a graphic object or information on the screen, and to paste it at a different location.
4. Scroll. To cause information to move on the screen so as to reveal information currently not visible to the user.
5. Drag. To move an on-screen object or information from one location on the screen to another.
6. Browse/Navigate. To open a viewer to examine content. In this non-limiting example, the content is a webpage. Navigation occurs when moving back and forth between pages in the browser history, or between pages within a document.
7. Menu. To display a list of options that trigger other actions when selected.
8. Play Sound. To play a sound or music.
9. Start Application. To start a computer application.
10. Spaces (display views). To move between displaying off-screen graphics environments.
11. Resize/Scale. To enlarge or shrink information on screen.
12. Share. To share information with others, in a non-limiting example, in your online social network.
13. Open, Save and Close. To open a document for reading on said screen, or to close it. To save the document in its present state.
14. Communicate. To video conference, telephone, text message or email, or to open connections to said service.
15. Connect. To connect to a network, or other container.
16. Socially network. To connect, or alter the user's social network or online status, or to communicate the container content to others, or to other containers.
17. Order. To order or pre-order drinks via a wireless network.
18. Authenticate. To allow access to digital content on the container upon verification of identity, for example, through fingerprint or facial detection. Includes contextualization of content on the basis of the user, or automatic engagement of parental control settings or personalization on the basis of the identified user.

### Apparatus

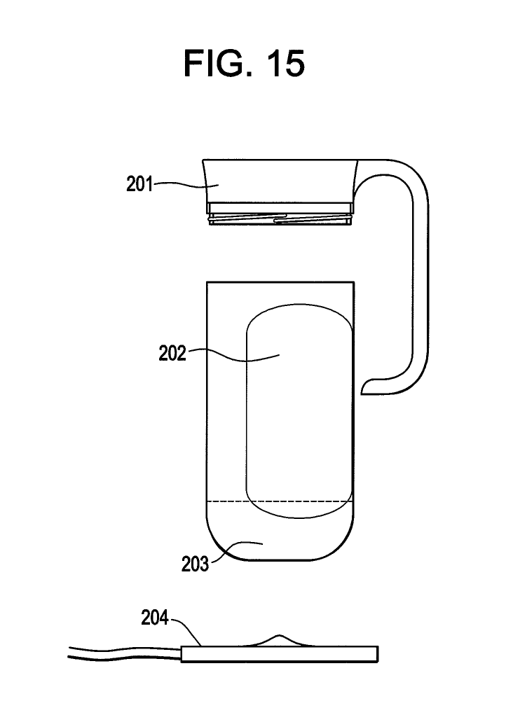

FIG. 15 shows the preferred embodiment of an electronic food or beverage container. In this embodiment, the beverage or food container consists of four components. A first component is the drinking lid, and fits atop of two universal components (201). A second component consists of the actual container, with the interactive display and touch input technology wrapped around the outside of said container (202). The third component is a universal component (203) that contains the computer, network and power apparatus, as detailed under section 3. In one embodiment, said two components are integrated into a single unit for convenience. A fourth, optional, component is an accessory dock (204) that can serve, for example, as a charger and network connection. In its preferred embodiment, the device consists of the following non-limiting list of elements:

1. Sensors

The container contains sensors that allow sensing of interactions selected from the above list of interaction techniques, in addition to content measurement, location and proximity and altitude sensing and the like. In one embodiment, said sensors or a sub-selection of sensors is contained in the customizable lid component (see section 2. below). In another embodiment, they are contained within one of the universal components, with sensors optionally being placed inside the actual container to be able to sample properties of its contents.

Sensors are selected from the following (non-limiting) group consisting of:

1. 6-axis Accelerometers

2. (Nonplanar) Multitouch screen

3. Capacitive touch sensor

4. Galvanic skin conductor.

5. Alpha

6. Camera: video and still.

7. Hygrometer.

8. Liquid Level Sensor.

9. Potentiometric Liquid Chemical Sensor.

10. Altimeter.

11. Thermometer.

12. Force sensor.

13. Pressure sensor.

14. Microphone.

15. Speaker.

16. GPS.

17. Relays.

18. Buttons.

19. Photoelectric Sensor.

20. Proximity Sensor.

21. Wireless network (Wifi/Bluetooth/ZigBee).

22. Rumble charger and docking electrodes.

23. An RFID payment system.

24. RFID,

25. A wired network connector.

26. A battery recharging connector.

27. An audiovisual connector.

1. Customizable Drink Lid

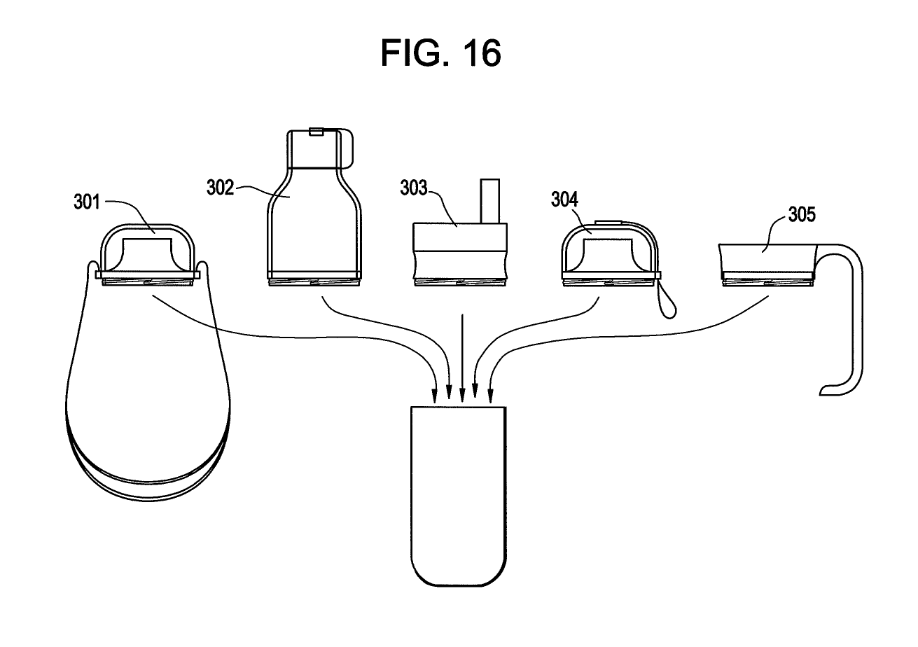

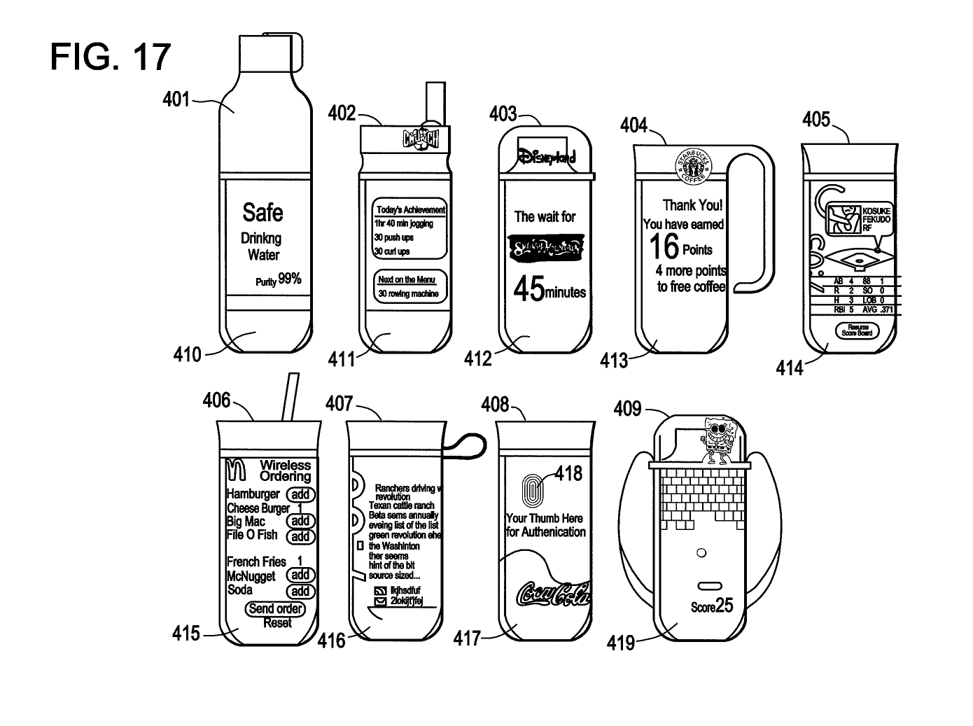

In its preferred embodiment, the drink lid component (201) is fully customizable and interchangeable between uses. Said component allows for differentiation of form factors and marketing content or branding, as shown in FIGS. 16 and 17. Form factors for the drinking lid include but are not limited to water bottle tops (302 401), cup lids with handle (305 404), children's or baby bottle tops (304 409), sports bottle tops (303 402) and the like. Said component may also contain specialized accessories, sensors and add-ons, selected from, but not limited to, the list consisting of a water purification system; Ultraviolet light filtration, carbon filtration; chemical or organic content or bacterial content analyzer; amplification or speaker system; compass or GPS; fitness equipment interfaces; RFID tag and any and all sensors from the list provided in this patent under 1. Sensors. An RFID tag in the drinking lid may used to identify to the other components which type of drinking lid is currently in use.

2. Interactive Display/Container Component

FIG. 15 shows the invention in its preferred embodiment. The central feature on the container is a non-planar display covering or partially covering the container (202). In this non-limiting example, the display is wrapped around the circumference of a cylindrical container form factor. The display technology is selected from, but not limited to one of the following: Flexible E-Ink; Flexible Organic Light Emitting Diode; Flexible LED Arrays; Projection by an external light source; Paintable display and other non-planar display technology. All interaction techniques operate on any side of said non-planar display through an incorporated non-planar multitouch input technology. In our preferred embodiment, the display wraps around such that there are no visible bezels separating segments of said display. In another embodiment, part of the container is flattened (202), and this area functions as the main interaction area. In another embodiment, only the flattened zone has touch capabilities.

In one embodiment, the display of the container can be customized with personal or shared screen savers or backgrounds, which serve to personalize the container for a user. In another embodiment, said screensavers or background serve as marketing material by manufacturers of food or beverages, or as advertisement by third parties. In another embodiment, the food or beverage container may automatically alter the personalization of its display depending on detecting patterns of use, including but not limited to drinking or food consumption behavior, day of the week or time, altitude, acceleration, GPS coordinates, detection by the universal component of a customized lid or any other contextual information sensed by or provided to the device. Contextualization of the display may also pertain to the initial functionality offered on said display. For example, when the display senses a customized hiking lid with compass functionality, it may automatically display application icons on its display pertaining to said activity. When it senses a baby bottle top, it may automatically switch to the functionality or content relevant to that age category or task. When it senses a change in mood through a galvanic skin response sensor or other means, it may change the display or music played on the device to suit said mood. In one embodiment, an application store is provided on the display that allows users to purchase application content, goods, media or software through an internet connection.

3. Computer, Network and Power Component

FIG. 15 shows the bottom part (203) of the central component containing the hardware computing apparatus in its preferred embodiment, selected from, but not limited to a list of; battery; power connector; network connector; audiovisual connector; cpu and graphics circuit board; RAM memory and Firmware ROM; flash or hard disk drive; accelerometers; wifi/bluetooth/3G/4G wireless network adapter; secure payment system chip; RFID tag and camera.

4. Accessory Base

FIG. 15 also shows the fourth and optional component, a base that allows the unit to recharge its batteries (204). In one embodiment, said base may contain a heating element to reheat or keep heated the content of said container. In another, the base may contain a network connector, allowing said container to connect through an Ethernet or other such network connection.

5. Product Refilling Station

In one embodiment, said invention requires a compatible refilling station. This refilling station communicates with said product container upon placement of said product container on the refilling station, which is referred to as docking. The refilling station may, upon docking with the container, initiate a recharging of said container's batteries for the duration of the filling procedure. The refilling station may upgrade software, collect payment data, usage data, or user data through a wired or wireless connection upon docking. In another embodiment, the container is filled manually. In this case, a liquid chemical sensor inside the container may sense the contents of the container, or the history of orders or recipes ordered may be automatically registered in the memory chip of the container. Alternatively, the dispenser or purveyor's computer system may communicate such information to the container. Alternatively, drinks that are dispensed through a refilling station can be automatically identified and maintained in memory;

In one embodiment, a user selects and pre-orders the contents through interactions with the container. Upon pressing the order button on said container, said order is digitally communicated to the purveyor, who then uses this information to prepare its lineup of drink preparations.

In another embodiment, beverages may be selected on the filling station's display. In one embodiment, the container's display may use online mapping software indicate the location of the nearest filling station or purveyor, and/or provide directions to the user to said station on the container's display. The target of the order may be determined by selecting the purveyor from a map or from a list, or from a contextually provided list of purveyors within a certain range of proximity. Alternatively, the order may be sent to the closest purveyor automatically. Drink orders can be communicated to said filling station upon an on-screen button press, or upon placing the container in the refilling station.

In one embodiment, payment of the beverage is managed through an online system the user interface of which is provided on the container. In another embodiment, the container contains an embedded RFID payment system for this purpose, which is read upon docking the container. In one embodiment, payment involves the automated purchasing of carbon offset credits aimed at neutralizing the climate impact of the resources used in the manufacturing and delivery of the order. An online system may be used to calculate the exact carbon emissions based on the sourcing of ingredients, distance traveled to obtain the order, and distance traveled by said ingredients, and the like.

Drink orders may be selected from a list of available beverages, or a personalized mix may be created by selecting ingredients and amounts from an online recipe list that is shared with others. A list of popular mixes may be communicated to an online system for the purpose of social networking, so as to communicate who is drinking what from their container. Drinks may be purchased by selecting them from a list of popular drinks consumed by others, or by selecting from celebrities or friends' lists.

In one embodiment, drink volume is selected by choosing a volume from a list, in another by typing or selecting a monetary amount from a list, provided that said amount does not overfill said container.

In one embodiment, upon refilling, the station first cleans the beverage container using high-pressure cleaning liquids. The cleaning cycle may include a rinse prior to filling of the container with the selected beverage. To this effect, the bottom of the container may hold a valve through which the cleaning liquids can be flushed upon completion of the cleaning cycle. An optional non-limiting alternative to the use of cleaning liquid is the use of ultraviolet light to sanitize the container prior to filling. Another non-limiting alternative to the use of a valve is for the machine to tip the container and empty it after cleaning, or to request the user to pick up the container and empty it in a designated area. In another embodiment, the user leaves one of his or her containers at a special station, placed in a café or bar, for cleaning. In this scenario, the user receives credit for picking up another container filled with a fresh beverage or food order upon obtaining said order. Said second container may have been in use by someone else, or may be owned by the user. In the latter case, an automated system, through REID identification, keeps track of ownership of containers. Upon picking up a new container, all personal information is automatically transferred to the new container over a network. Alternatively, component 3, which contains all the logic and memory of the device is removed upon placing the container unit in the cleaning facility.

The progress of filling is displayed through an animation on the container's display, and may be accompanied by an auditory progress indicator. Upon completion of the filling process, the container may communicate with the user through auditory or visual means. The display, or part of the display, may be branded with information and advertising for the drink that the container is holding, or by third party advertisements. Said advertisements may include text, images and moving images. Promotional application contents such as games, lotteries, advertisements or promotions and such associated with said drink purchase may be downloaded to said container upon said drink purchase, or upon docking.

### Example 4

There are many usage scenarios that would benefit from the functionality provided by the interactive food and beverage container. This Example highlights a few applications of said container.

4.1. Morning Rush Hour/News Theme

In this non-limiting example, the container is used to read the morning news while enjoying a cup of coffee. Here, the user gets up in the morning to prepare a coffee to go. As he picks up his container (407), its display wakes up and automatically shows him today's weather forecast for the current location. The user taps the order icon, causing an application to start up that, based on his current location, determines the user would like to brew his or her's own coffee. It presents a menu for the coffee machine, which is a fully automated personalized brewing machine. After choosing from the available brews, the user taps the Order button on the screen, which is communicated to the coffeemaker through a wireless network. The coffee maker starts brewing the selected beverage, while the user is under the shower. When he gets down, he walks to the coffeemaker and docks his container underneath the drip. The coffeemaker fills the container. The container shows an animation of it filling up. Alternatively, the user puts the container in the coffeemaker prior to brewing. Alternatively, the user simply brews and pours his manually produced coffee in the container. In one embodiment, the container indicates that it is full through an auditory or visual alert. The user picks up his container after it is full and walks to his car. He hits a traffic jam and taps the RSS icon to read his favorite news feeds (416). The newsreader application starts and provides him with a list of feeds. The user decides to read the morning news, which is displayed after tapping a link. One of the links provides a video feed of today's newscast. The user taps it and a video feed is displayed on the container's screen. At the next stop, the user flicks his container to open the next article. When his coffee is finished, he finds himself stuck again, and rotates the beverage container 90 degrees, holding it with both hands. The user rotates the container as he reads the morning news article full screen on the beverage container. The user can continue rotating the display until the bottom is reached, making full use of the round display surface, which continues to scroll and provide new information even when the user has rotated the container a full 360 degrees.

When the user continues driving, he places his container in the cup holder. The container now becomes an interface to the car's audiovisual equipment, with the media held in the memory chip or hard drive of the container and with audiovisual information streamed from the container through a physical connection in the cup holder to the car stereo. The display also takes on the appearance or aesthetics of the car's interior so as to blend in with its environment. Rotation in the cup holder causes stations on the radio to dial, or to skip to next mp3 in the list playing on the container. When it is time to stop at a gas station, the container is used to complete the purchase of gas, including any automated carbon offset purchases. After filling the gas tank of his car, the user is automatically rewarded with points and/or coupons for his purchase, while the container updates and keeps track of the mileage obtained between gas fills.

Alternatively, the container may be used by a commuter in a public transport setting to obtain access to said public transport, download route and timetable information and planning, as well as provide navigational services. In this context, the container may also be used to provide estimated time of arrival of a selected public transportation system.

4.2. Health/Dietary Theme

In this non-limiting example, the container (402) keeps track of the user's caloric or ingredient intake per day. Upon selecting a drink or food item, the user is provided with a browser that provides online information about the ingredients, nutritional value, and sourcing, for example, the farm from which the ingredient was purchased. It may also provide information about the C02 that was consumed to produce a particular ingredient or drink, how far it traveled, and may provide a user interface for compensating for such carbon uptake. Upon reaching a set caloric, sugar, monetary, fluid or caffeine threshold for the day's budget, the user may be alerted as to whether to proceed with the order, and whether to subtract the uptake from the next day budget. The container tracks the user's drinking patterns per day, providing information on the volume of fluids consumed, and when and what drinks were consumed. The user may browse statistics of his or her uptake on an hourly, daily, weekly, monthly or yearly basis through a user interface provided for this purpose, and may choose to share this information with others. When the user is not achieving sufficient hydration for today's weather or temperature, the container may alert the user. When the user enters a gym, the container communicates the gym membership number to the entrance system of the gym. When the user uses a fitness machine, a cup holder on said fitness machine serves as a charging station and computing or network interface to the container. This connects the container to said fitness machine, allowing it to track the effort expended during the fitness routine, and provide statistics on prowess or training schedule (411). In another embodiment, the container serves as a coach, stepping the user through a series of fitness routines contextualized by the information provided by said fitness machine. In another embodiment, the container provides gaming or racing content that interacts with said fitness machine, or other fitness machines either in the same fitness center, or remotely, so as to allow two or more users to compete against each other in their fitness activity. In another embodiment, multiple runners can compete against each other through information provided through an (adhoc) wireless network of containers.

4.3. Social Networking/Celebrity Theme

In this non-limiting example, the user selects his food or beverage by choosing from an online list of favorites consumed by his friends, or by celebrities. This list may or may not be synchronized with or provided through an online social networking site, such as facebook. Whenever the user selects a drink, his or her online profile is updated with the latest drink choice, and his most popular choices are tallied and made available to his friends.

4.4. Mixing Theme

In this non-limiting example, the user chooses the ingredients for his food or beverage from a list of available ingredients. First, the user selects a location to obtain his drink from a map, or simply chooses the nearest location provided by his GPS coordinates. In one embodiment, at the location, a specialized fully automated beverage mixing machine is available, such as, for example, a Clover coffee maker, or a similar automated machine for mixing cold beverages or food items. This machine has an online interface to which the container connects via a wireless internet connection. The container lists the available ingredients at that location, for that machine. The user selects ingredients from the list, for example, 80% carbonated water, 10% coffee syrup, and 10% coca cola extract. Upon placing the order for the beverage, the machine is informed of the order, which is processed in line. Upon placing the beverage container in the dispenser, the drink, already mixed, in dispensed into the container. The same scenario may apply to food orders such as noodles and the like, which may be selected, processed and dispensed in a similar fashion as beverages.

4.5. Exercise/Hiking Theme

In this non-limiting example, the container is hooked onto a belt for the purpose of bringing it along on a jog, hike, or other form of exercise activity, or placed in a holder on a bicycle for providing hydration or food during the activity (401). The built-in GPS senses the distance traveled, and maps this information. It may also count steps to provide some indication of the number of calories burnt, or fluids lost, which information may be use to alter the uptake budget discussed in the health/dietary example. Alternatively, the user may pick up the container to use its services as a tool for way finding. A compass on the cap of the container may provide directions while traveling, while the display can be used to select waypoints on a map. Alternatively, a route may be predetermined on said map, or downloaded from an online database of routes. Routes may be automatically shared to a social network through the same means as described for choosing drinks in the social networking example. The container may also sense the altitude of the user, and use this information to compute the total amount of effort exerted during the exercise routine. The drinking lid of the container may contain a water purification filter (401) that allows the user to use the container to obtain drinking water from mountain streams. Users may share or update lists of locations of drinkable water sources, or the container may automatically analyze the purity of the water to compile such list, and/or inform the user of the safety of said water source (410).

4.6. Media Player Theme

In this non-limiting example, the container (404) is used to browse and/or buy music or videos or other such media made available at a drinks or food outlet. For example, upon entering a Starbucks coffee location, the user might be presented with a user interface for browsing their music catalogue, and purchase mp3 music files or videos through the user interface presented on the beverage container (413). A hyper-localization feature allows each food outlet to have a unique selection or promotional activity, offering media to the taste of their users while requiring them to come to the location in order to be made such offers. The music currently playing at said location is provided on the container as well. The infinite scrollability of the screen allows large catalogues to he browsed with ease.

4.7. Kids/Game Theme

In one embodiment, the form factor of the container is designed to function as a reusable bottle or blended food container for babies and young children (409). The container offers a user interface with games that interact with the level and physics of the food or beverage inside the container such that shaking the container may provide input to said games. Alternatively, the level of liquid or food in the container functions as an incentive in the game, and the child is offered rewards such as access to levels, scoring of points, or auditory visual stimuli to encourage the finishing of said food item or drink. For example, finishing the drink or food item may be an important step to get to the next level of a game, and a special reward may be given after the drink is finished. Time-outs or alerts may be used to ensure children finish their food or drink rather than continuing to play with it. In this embodiment, the container may also function as an automated measuring device that alerts the user when a certain level is reached. The food or beverage container may also be used as an input device to television screen games, for example, to simulate a water fight with your drink container, or to have a light saber tight. As such, its input sensors serve to provide information to a game console similar to a Wii Remote. In another embodiment, parents can use the container as a monitor for their child. Parents will know dynamically where their children are, based on GPS and the like, and whether they are consuming their beverages or receiving the necessary amounts of nutrients and hydration. Parents and children can also use their containers as communication devices. Likewise, children can use the container to communicate with their friends in the playground and beyond. This wireless communication service can also be used in situations where children are playing games on their beverage container together. Children can use the container as an educational device while in the school classroom. Interactive educational content can be wirelessly sent to each student's container by the instructor. Parental or school controls can be set to de-activate non-educational activity during school hours.

4.8. Restaurant/Drive Through Theme

In this non-limiting example, the container (406) is used to order drinks and/or food items in a fast food restaurant drive through or walk in. Upon reaching the drive through line up, the outlet is displayed as being the closest to the user. The user selects the outlet, upon which the container displays a list of available beverages and or food items at the outlet (415). The user makes his selection while waiting in line, and taps the order now button. This causes the order and payment to be transmitted to the operator inside the outlet through a secure wireless internet connection. Alternatively, payment may be made through an RFID payment system chip inside the container upon placing it on the counter of the outlet. The user can skip the task of ordering items through the speaker system, and go straight to a window to collect the items ordered. Alternatively, the user may, upon stopping the car at the parking lot, transmit his order to the outlet, and walk into the outlet without lining up for the counter. When the item is ready for pickup, this is communicated to the user through an alert on his or her beverage or food container. Alternatively, a server may locate the user in the restaurant through a signal from his or her container and deliver the order. In another embodiment, the restaurant may upload promotional games or lotteries onto the container, for example, similar to Tim Horton's roll up the rim contest. Users may be required to play a game on their container prior to winning a prize, or may be provided with free content, tickets, media and the like upon purchasing a food or drink item at the outlet.

4.9. Event Theme

In this non-limiting example, the user brings his container (405) to a sports or music event. Prior to going to the event, the user orders his or her ticket using his container display. The container then serves as a secure and physical ticket, or season pass. In one embodiment, the user authenticates by placing a finger on the fingerprint reader (418). Upon reaching the gate, the container is scanned through the RFID payment chip or some other secure means, after which the user is allowed into the event. Optionally, a digital program of the event is automatically downloaded upon entry. During the game, the user can use a user interface provided on the container to purchase highlights of the game or concert, or record personal information about the event. After entry, the container may automatically offer to direct the user to his or her seat as appropriate. During a game or concert, users may be prompted to hold up their container at a specific moment in time, upon which an image may be displayed across all containers in a stadium, with each container acting as one pixel in the image, so as to allow synchronized cheering. In one embodiment, the container may provide an interface to statistics, information, or video images, real-time or archived, of the currently relevant player in a sports match (414). This may, for example, be the player currently holding the ball. During the break, users may obtain information about what beverage their favorite player is consuming.

4.10. Airline/Travel Theme

In this non-limiting example, the user brings his or her container on an airline trip. The user can pre-order boarding passes through the container. In one embodiment, the user authenticates by placing a finger on the fingerprint reader (418). Upon entering the aircraft, the container acts as a ticket stub, providing access to the aircraft. The container's display or compass provides the user with directions to his or her seat. Upon seating, the user can select from a customized menu that allows him or her to order available foods from the food service.

4.11. Theme Park Theme

In this non-limiting example, a family goes to a Disney theme park in Orlando. They each bring their beverage container (403), which has been linked to their entrance tickets through an online system. In one embodiment, as they enter the park, each person logs into his or her container by placing a finger on the fingerprint reader (418). An RFID tag in their container is scanned at the entrance gate, identifying the container and ticket, upon which the family receive a number of free food and drink tokens on their cup for later consumption. As part of their admission, each of the family members receives a new lid branded with a Disney theme park logo. Much to their enjoyment, the children receive a lid with Mickey Mouse ears on it that light up as they consume a beverage. Upon placing the lid on their container, the skin of the container changes to a Disney theme that includes an event browser, and a map with a ride reservation interface and some suggested itineraries. The GPS in the lid keeps track of where each of the family members is, allowing routing between rides. The family chooses Pirates of the Carribean on the map. A menu pops up informing them when the ride is available (412). They select a time and continue planning their visit. The map updates with wait times for each ride. At 1.00 PM the container beeps, informing the family that their ride is upcoming. However, one of the kids is missing. The map on the container indicates the person's location, and the family quickly regroups. Upon entering the ride, the reservation is automatically read from the container. The picture taken during the ride is offered for purchase on the container after leaving the ride area. Upon returning home, the container offers a lasting souvenir of their visit: every time they place the Disney lid on the device, the itinerary, activities, diary and photos that were made that day appear for sharing with friends.

4.12. Vending Machine Theme

In this non-limiting example, a user uses his container (408) to obtain a beverage from a vending machine. Upon approaching the nearest vending machine, a menu pops up that allows the user to select a beverage. The user authenticates a purchase by placing a finger on the designated fingerprint reader device (418). Upon placing his container on the cupholder, the machine rinses the container, after which it gets filled with the selection. The screen changes to reflect the logo of the beverage it now contains As the container fills, an animation shows prowess (417). Alternatively, while waiting, the user is entertained through media content downloaded by the beverage machine onto the container. The charge for the beverage is automatically debited through an RFID payment system disposed on the container. A points system awards the user for each purchase that is made through the reusable container with a carbon credit or bottle return credit, rewarding the user for not requiring disposable containers.

4.13 Office Theme

In this non-limiting example, the user enters his office with his cup after the morning commute, and places the cup in his charger accessory. The container recognizes it is now in the workplace and displays relevant application contents, such as a clock or calendar. It also features a map of the facility, with a status for the closest coffeemakers. When it is time for a cup of coffee, the user is directed to the nearest coffeemaker that contains fresh coffee. After returning to the desk, the user wants to download a pdf for reading during the evening commute to the container. He does so by dragging the icon of the document on the desktop of his computer to the icon of the container on said desktop. The document is copied to the container where it is made available for later use.

### Example 5

### Flexible Textile Display

In this non-limiting example the flexible display surface consists of electronic textile displays such as but not limited to OLED textile displays known in the art, or white textiles that are tracked and projected upon using the apparatus of this invention. These textile displays may be worn by a human, and may contain interactive elements such as buttons, as per Example 3. In one embodiment of said flexible display fabric, the textile is worn by a human and the display is used by a fashion designer to rapidly prototype the look of various textures, colors or patterns of fabric on the design, in order to select said print for a dress or garment made out of real fabric. In another embodiment, said textures on said flexible textile displays are permanently worn by the user and constitute the garment. Here, said flexible display garment may display messages that are sent to said garment through electronic means by other users, or that represent advertisements and the like.

In another embodiment, the flexible textile display is worn by a patient in a hospital, and displays charts and images showing vital statistics, including but not limited to x-ray, ct-scan, or MRI images of said patient. Doctors may interact with user interface elements displayed on said flexible textile display through any of the interaction techniques of this invention and any technique know in prior art. This includes tapping on buttons or menus displayed on said display to select different vital statistics of said patient. In an operating theatre, the flexible textile display is draped on a patient in surgery to show models or images including but not limited to x-ray, ct-scan, MRI or video images of elements inside the patients body to aid surgeons in, for example, pinhole surgery and minimally invasive operations. Images of various regions in the patient's body may be selected by moving the display to that region.

### Example 6

### Flexible Human Display

Alternatively, images of vital statistics, x-rays, ct-scans, MRIs, video images and the likes may be projected directly onto a patient to aid or otherwise guide surgery. Here, the human skin itself functions as a display through projection onto said skin, and through tracking the movement and shape of said skin by the apparatus of invention. Such images may contain user interface elements that can be interacted with by a user through techniques of this invention, and those known in the art. For example, tapping a body element may bring up a picture of the most recent x-ray of that element for display, or may be used as a form of input to a computer system.

### Example 7

### Origami Flexible Display

In this embodiment, several pieces of flexible display are affixed to one another through a cloth, polymer, metal, plastic or other form of flexible hinge such that the shape of the overall display can be folded in a variety of three dimensional shapes, such as those found in origami paper folding. Folding action may lead to changes on the display or trigger computer functionality. Geometric shapes of the overall display may trigger behaviors or computer functionality.

### Example 8

### Flexible Input Device

In this embodiment, the flexible surface with markers is used as input to a computer system that displays on a standard display that is not said flexible surface, allowing use of said flexible surface and the gestures in this invention as an input device to a computing system.

The contents of all cited patents, patent applications, and publications are incorporated herein by reference in their entirety. While the invention has been described with respect to illustrative embodiments thereof, it will be understood that various changes may be made in the embodiments without departing from the scope of the invention. Accordingly, the described embodiments are to be considered merely exemplary and the invention is not to be limited thereby.

### REFERENCES

1. Balakrishnan, R., G. Fitzmaurice, G. Kurtenbach and Singh, K. Exploring Interactive Curve and Surface Manipulation Using a Bend and Twist Sensitive Input Strip. In Proceedings of the 1999 Symposium on Interactive 3D graphics, ACM Press, 1999, pp. 111-118.
2. Fishkin, K., Gujar, A., Harrison, B., Moran, T. and Want, R. Embodied User Interfaces for Really Direct Manipulation. In Communications of the ACM, v. 43 n. 9, 2000, pp. 74-80.
3. Guimbretière, F. Paper Augmented Digital Documents. In Proceedings of UIST 2003. Vancouver: ACM Press, 2003, pp. 51-60.
4. Holman, D., Vertegaal, R., Troje, N. PaperWindows: Interaction Techniques for Digital Paper. In Proceedings of ACM CHI 2005 Conference on Human Factors in Computing Systems. Portland, Oreg.: ACM Press, 2005.
5. Ishii., H. and Ulmer, B. Tangible Bits: Towards Seamless Interfaces Between People, Bits and Atoms. In Proceedings of CHI 1997. Atlanta: ACM, 1997, pp. 234-241.
6. Johnson, W., Jellinek, H., Klotz, L., Rao, R. and Card S. Bridging the Paper and Electronic Worlds: The Paper User Interface. In Proceedings of the INTERCHI 1993. Amsterdam: ACM Press, 1993, pp. 507-512.
7. Ju, W. Bonanni, L., Fletcher, R., et al. Origami Desk: Integrating Technological Innovation and Human-centric Design. In Proceedings of DIS 2002. London: ACM Press, 2002, pp. 399-405.
8. Klemmer, S., Newman, M., Farrell, R., Bilezikjian, M. and Landay, J. The Designers' Outpost: A Tangible Interface for Collaborative Web Site Design. In Proc. of UIST 2001. Orlando: ACM Press, 2001, pp. 1-10.
9. Lange, B., Jones, M., and Meyers, J. Insight Lab: An Immersive Team Environment Linking Paper Displays and Data. In Proceedings of CHI 1998. Los Angeles: ACM Press, 1998, pp. 550-557.
10. Levine, S. R. and S. F. Ehrlich. The Freestyle System: A Design Perspective. Human-Machine Interactive Systems, A. Klinger, Editor, 1991, pp. 3-21.
11. Mackay, W. E. & Fayard, A-L. Designing Interactive Paper: Lessons from Three Augmented Reality Projects. In Proceedings of IWAR'98, International Workshop on Augmented Reality. Natick, Mass.: A K. Peters, Ltd., 1998.
12. Moran, T., Saund, E., Van Melle, W., Gujar, A., Fishkin, K. and Harrison, B. Design and Technology for Collaborage: Collaborative Collages of Information on Physical Walls. In Proceedings of UIST 1999. Asheville, N.C.: ACM Press, 1999, pp. 197-206.
13. O'Hara, K. and Sellen, A. A Comparison of Reading Paper and On-line Documents. In Proceedings of CHI 1997. Atlanta: ACM. Press, 1997, pp. 335-342.
14. Philips OLED Technology. http://www.business-sites.philips.com/mds/section-1131/
15. Piper, B., Ratti, C. and H. Ishii. Illuminating Clay: A 3-D Tangible Interface for Landscape Analysis In Proceedings of CHI 2002. Minneapolis: ACM Press, 2002.
16. Rekimoto, J. Pick-and-Drop: A Direct Manipulation Technique for Multiple Computer Environments, In Proceedings of UIST 1997. Banff: ACM Press, 1997, pp. 31-39.
17. Rekimoto, J. Ullmer, B. and H. Oba, DataTiles: A Modular Platform for Mixed Physical and Graphical Interactions. In Proceedings of CHI 2001. Seattle: ACM Press, 2001.
18. Rekimoto, J. SmartSkin: An Infrastructure for Freehand Manipulation on interactive Surfaces. In Proceedings of CHI 2002. Minneapolis: ACM Press, 2002, pp. 113-120.
19. Schilit, B., Golovchinsky, G., and Price, M. Beyond Paper: Supporting Active Reading with Free Form Digital Ink Annotations. In Proceedings of CHI 1998. Los Angeles: ACM Press, 1998, pp. 249-256.
20. Schwesig, C., Poupyrev, I., and Mori, E. Gummi: A Bendable Computer. In Proceedings of CHI 2004. Vienna: ACM Press, 2003, pp. 263-270.
21. Sellen, A., and Harper, R. The Myth of the Paperless Office, MIT Press, Cambridge, Mass., 2003.
22. Sun Starfire: A Video of Future Computing. http://www.asktog.com/starfire/starfirescript.html.
23. Vicon. http://www.vicon.com
24. Weiser, M. The Computer for the 21st Century. Scientific American, 1991, 265 (3), pp. 94-104.
25. Wenner, P. The DigitalDesk Calculator: Tangible Manipulation on a Desk Top Display. In Proceedings of UIST 1991. Hilton Head: ACM Press, 1991, pp. 27-33.

1. A reusable portable interactive apparatus comprising:
a container portion with a display comprising a flexible display technology and a display surface visible on an outer surface of the container portion;
a base portion;
a computing device electrically connected to the flexible display technology, comprising one or more of battery, power connector, network connector, audiovisual connector, central processing unit, wireless network transceiver, graphics circuit board, RAM memory, firmware ROM, flash memory, and hard disk drive;
at least one liquid chemical sensor in communication with an inside surface of the container portion that senses a chemical characteristic of contents of the container portion, and outputs a chemical sensor signal to the computing device;
at least one motion-sensing device that senses motion of the apparatus and outputs a motion sensor signal to the computing device;
wherein the computing device produces an output based on at least one of the chemical sensor signal and the motion sensor signal; and
wherein the computing device output comprises one or more of a visible change in the flexible display, a change in a wireless network transceiver signal, and an outputting or receiving of a wireless network transceiver signal.

2. The apparatus of claim 1, further comprising one or more sensor selected from the group consisting of 6 DOF accelerometer, gyroscope, bend sensor, touch screen, capacitive touch sensor, heart rate sensor, galvanic skin conductor sensor, alpha dial potentiometer, video camera, still camera, hygrometer, liquid level sensor, altimeter, thermometer, force sensor; pressure sensor, microphone, GPS, photoelectric sensor, proximity sensor, RFID tag, fingerprint reader, chemical or organic content analyzer, bacterial content analyzer, and compass.

3-20. (canceled)

21. The apparatus of claim 1, further comprising one or more of a water purification system, ultraviolet light purification system, carbon filtration system, and audio amplification and loud speaker system.

22. The apparatus of claim 1, wherein the wireless network transceiver is compatible with one or more communications system selected from Wifi, Bluetooth, and ZigBee.

23. The apparatus of claim 1, wherein the flexible display comprises at least one technology selected from flexible e-ink, flexible organic light emitting diode, flexible light emitting diode, projection, laser, and paintable display.

24. The apparatus of claim 1, wherein user input is provided by at least one of touching the apparatus and gestural interactions that produce motion of the apparatus.

25. The apparatus of claim 1, wherein the apparatus compiles, stores, displays, and/or outputs information about one or more of type, amount, characteristic, and frequency of contents in the container portion.

26. The apparatus of claim 25, wherein the information includes history of orders of beverages and/or foods.

27. The apparatus of claim 25, wherein the apparatus communicates with a vendor of the beverages and/or foods in respect of the information.

28. The apparatus of claim 25, wherein the apparatus relates the information to the user's drinking pattern, volume of fluids consumed, and when and what drinks were consumed.

29. The apparatus of claim 25, wherein the information is organized on an hourly, daily, weekly, monthly, or yearly basis.

30. The apparatus of claim 25, wherein the apparatus shares the information on a network.

31. The apparatus of claim 25, wherein the apparatus provides an alert when at least a portion of the information is not within a selected range.

32. The apparatus of claim 25, wherein the one or more characteristic is one or more parameter is selected from nutritional value and caloric value.

33. The apparatus of claim 32, wherein the one or more characteristic is determined based on the liquid chemical sensor signal.

34. The apparatus of claim 1, wherein the apparatus receives information about one or more parameter of the contents of the container from a vendor or provider of the contents, wherein the one or more parameter is selected from nutritional value and caloric value.
